(19) United States
(12) Patent Application Publication
(10) Pub. No.: US 2025/0315892 A1
(43) Pub. Date: Oct. 9, 2025

(54) Efficient numerical Monte Carlo sensitivity analysis

(71) Applicant: COMMONWEALTH SCIENTIFIC AND INDUSTRIAL RESEARCH ORGANISATION, Acton, Australian Capital Territory (AU)

(72) Inventors: Blessing Taruvinga, Acton, Australian Capital Territory (AU); Zili Zhu, Acton, Australian Capital Territory (AU); Geoffrey Lee, Acton, Australian Capital Territory (AU); Dan Zhu, Acton, Australian Capital Territory (AU)

(21) Appl. No.: 18/865,079

(22) PCT Filed: May 12, 2023
(86) PCT No.: PCT/AU2023/050400

§ 371 Date: Nov. 12, 2024

(30) Foreign Application Priority Data
May 13, 2022 (AU) 2022901275

(51) Int. Cl. G06Q 40/06; G06F 17/17; G06F 30/23

(52) U.S. Cl. CPC G06Q 40/06; G06F 17/17; G06F 30/23

(57) ABSTRACT

This disclosure relates to implementing Monte Carlo sensitivity analysis on computer processors in a manner that is efficient in the number of required Monte Carlo samples. A processor repeatedly evaluates a model along a sample path with a first parameter set to obtain multiple first sample values, aggregates the multiple first sample values to obtain a first density profile, then smooths the first density profile using a parameterised interpolation function to obtain a first smooth density profile. The processor then repeats this with a second parameter set to obtain a second smooth density profile, the first and second parameter sets being perturbed relative to one another. The processor then calculates a finite difference based on the first and second smooth density profile, subject to a discontinuous payoff function, to obtain a sensitivity of a financial derivative, the sensitivity being stable as a result of the smoothing.

### CROSS-REFERENCE TO RELATED APPLICATIONS

The present application claims priority from Australian Provisional Patent Application 2022901275 filed on 13 May 2022, the contents of which are incorporated herein by reference in their entirety.

### TECHNICAL FIELD

This disclosure relates to implementing Monte Carlo sensitivity analysis on computer processors in a manner that is efficient in the number of required Monte Carlo samples.

### BACKGROUND

Sensitivity analysis is a technique used in a range of engineering disciplines. In most cases, the aim is to find the influence of a specified parameter on an output measurement. For example, the delay of a digital electronic circuit may be sensitive to a number of physical parameters, such as temperature and supply voltage.

In other areas, such as finance, sensitivity analysis may also be used to explore and hedge accurately the influence/impact of financial market input measures on the price or value of a financial derivative.

The overarching concept, which is similar across engineering, financial and other applications is that a larger number of Monte Carlo samples (simulations) improves the accuracy and robustness of the calculated/predicted result but also increases the computation time to obtain this result. Importantly, accurately calculating sensitivity of the result to slight change in specific parameters requires an even higher number of Monte-Carlo samples. Generating accurate and robust sensitivity values relies on sophisticated Monte-Carlo algorithms and large computing resources. In an abstract setting, there is no limit to the number of Monte Carlo samples, but in practice, only finite number of Monte-Carlo samples can be used because the computation resources are finite. However, when the sensitivity analysis is implemented in a practical computer system, there is a technical problem that needs to be overcome in order to achieve improved accuracy using fewer resources. Of course, it is possible to deploy a greater number of resources, such as multiple/parallel processor cores to reduce the overall computational time. However, less accurate/robust sensitivity analysis is often implemented to fit within the permitted computing time. It would be preferable to obtain an accurate and robust result with fewer samples without sacrificing the accuracy of sensitivity analysis.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

A computer implemented method for computationally stable calculation of a sensitivity of a financial derivative comprises:
repeatedly evaluating a model along a sample path with a first parameter set to obtain multiple first sample values;
aggregating the multiple first sample values to obtain a first density profile;
smoothing the first density profile by interpolating the aggregated multiple first sample values using a parameterised interpolation function to obtain a first smooth density profile;
repeatedly evaluating the model along the sample path with a second parameter set to obtain multiple second sample values;
aggregating the multiple second sample values to obtain a second density profile;
smoothing the second density profile by interpolating the aggregated multiple second sample values using the parameterised interpolation function to obtain a second smooth density profile,
wherein the first parameter set and the second parameter set are perturbed relative to one another in at least one parameter; and
calculating a finite difference based on the first smooth density profile and the second smooth density profile, subject to a discontinuous payoff function applied to the smooth density profile, to obtain the sensitivity of the financial derivative with respect to the at least one parameter, the sensitivity being stable as a result of the smoothing.

It is an advantage to smooth the density profile as it causes the calculations of the sensitivities to be stable by mimicking an infinite number of sample values. This means fewer sample values are required with the guarantee of stability. Further, the calculation of the sensitivities is independent of the model used to determine the multiple sample values, enabling the method to be applicable to many different situations including engineering, physics, mathematics and finance.

In some embodiments, aggregating the multiple first and second sample values to obtain the density profile comprises dividing a range of the multiple first and second sample values into intervals and counting a number of the multiple first and second sample values in each interval.

In some embodiments, calculating the finite difference comprises evaluating the first smooth density profile, the second smooth density profile and the discontinuous payoff function at an average of each interval.

In some embodiments, smoothing the first and second density profile comprises interpolating a frequency of the multiple first and second sample values occurring at the average of each interval.

In some embodiments, calculating the finite difference further comprises summing over each interval.

In some embodiments, the discontinuous payoff function is discontinuous at a strike price.

In some embodiments, the sensitivity of the financial derivative is smooth and continuous with respect to the strike price.

In some embodiments, the model comprises a stochastic process.

In some embodiments, the sample path outputs a price of an underlying asset.

In some embodiments, each of the multiple first and second sample values is indicative of the price of the underlying asset at a time of maturity.

In some embodiments, the first smooth density function and the second smooth density function are functions with respect to the price of the underlying asset.

In some embodiments, each of the first parameter set and the second parameter set comprise one or more of initial price of the underlying asset, risk free interest rate, dividend rate and volatility.

In some embodiments, the volatility is variable with respect to time.

In some embodiments, the volatility is variable simultaneously with evaluating the model.

In some embodiments, the financial derivative is an option price.

In some embodiments, the at least one parameter comprises one or more of the price of the underlying asset, the risk free interest rate, the dividend rate and the volatility.

In some embodiments, the parameterised interpolation function comprises a cubic spline or polynomial.

In some embodiments, the first parameter set and the second parameter set are perturbed relative to one another by addition or subtraction of an incremental change in the at least one parameter.

In some embodiments, calculating the finite difference based on the first smooth density profile and the second smooth density profile comprises performing a subtraction of the first smooth density profile from the second smooth density profile.

In some embodiments, calculating a finite difference based on the first smooth density profile and the second smooth density profile further comprises dividing a result of the subtraction by the incremental change in the parameter.

Software, when executed by a computer, causes the computer to perform the above method.

A computer system for computationally stable calculation of a sensitivity of a financial derivative comprises a processor configured to:
repeatedly evaluate a model along a sample path with a first parameter set to obtain multiple first sample values;
aggregate the multiple first sample values to obtain a first density profile;
smooth the first density profile by interpolating the aggregated multiple first sample values using a parameterised interpolation function to obtain a first smooth density profile;
repeatedly evaluate the model along the sample path with a second parameter set to obtain multiple second sample values;
aggregate the multiple second sample values to obtain a second density profile;
smooth the second density profile by interpolating the aggregated multiple second sample values using the parameterised interpolation function to obtain a second smooth density profile,
wherein the first parameter set and the second parameter set are perturbed relative to one another in at least one parameter; and
calculate a finite difference based on the first smooth density profile and the second smooth density profile, subject to a discontinuous payoff function applied to the smooth density profile, to obtain the sensitivity of the financial derivative with respect to the at least one parameter, the sensitivity being stable as a result of the smoothing.

### BRIEF DESCRIPTION OF DRAWINGS

FIG. 1 illustrates a computer-implemented method for computationally efficient calculation of a sensitivity of a financial derivative.

FIG. 2 illustrates a computer system for computationally efficient calculation of a sensitivity of a financial derivative.

FIG. 3 illustrates the development steps of the new methodology.

FIG. 4a illustrates a graph of the S(T) frequencies for the GBM (Black-Scholes) model calculated using the PDF method.

FIG. 4b illustrates a graph of the S(T) frequencies for the Heston model calculated using the PDF method.

FIG. 5a illustrates a graph of the S(T) frequencies for the GBM (Black-Scholes) model calculated using the PDF method and cubic spline interpolation representing the smooth PDF.

FIG. 5b illustrates a graph of the S(T) frequencies for Heston model calculated using the PDF method and cubic spline interpolation representing the smooth PDF.

FIGS. 6a-6b illustrate graphs for the vanilla option prices and Greeks under the Heston model.

FIGS. 7a-7c illustrate graphs for the digital option prices and Greeks under the Heston model.

FIGS. 8a-8b illustrates graphs for the vanilla option prices and Greeks under the GBM (Black-Scholes) model.

FIGS. 9a-9c illustrates graphs for the digital option prices and Greeks under the GBM (Black-Scholes) model.

FIGS. 10a-10b illustrates graphs for the vanilla option prices and Greeks under the GBM (Black-Scholes) model with comparison to the likelihood ratio method (LRM).

FIGS. 11a-11b illustrates graphs for the digital option prices and Greeks under the GBM (Black-Scholes) model with comparison to the likelihood ratio method (LRM).

### DESCRIPTION OF EMBODIMENTS

Monte Carlo sampling method is used in financial markets and engineering systems for valuation, determination and prediction (i.e. the result) from uncertain but plausible input parameter set. The sensitivities to specific parameters are important measure of risk (for financial derivatives or climate) and confidence (in engineering design). As also explained above, there is a difficult technical trade-off between sample number and accuracy. This technical problem is more severe for some systems than for others. More particularly, discontinuities (e.g. discontinuous payout arrangement in finance, or abrupt change in the shape of a new airplane design or bridge) provide a severe obstacle, especially for second order sensitivities (i.e. second order derivatives). This is a problem because in order to capture a discontinuity exactly, an infinite number of samples is necessary. Therefore, it can be said that existing computer systems programmed using existing Monte Carlo methods and modelling are not able to accurately calculate second order sensitivities for systems with discontinuities. It should be noted that a large body of research literature has been devoted to this problem, however, solutions can generally be described as piece-meal approach without universal application.

Examples of problematic applications involve discrete parameters, such as breakthrough current of light emitting diodes (LEDs), discontinuous Hamiltonian dynamics in quantum physics, and statistical characteristics of geometric parameters of rock discontinuities in geology.

The problem is that the discrete (i.e. discontinuous) results have a first constant and smooth value across a wide space and a second constant value across almost the reminder of the result space. Only in a very small space between those two regions is there a very sharp change. It is very difficult to accurately capture sensitivities on that very sharp change region or point using Monte Carlo analysis on conventional computer systems. It was found that this problem is particularly severe for second order sensitivities

$$( i . e . \frac{{\partial }^{2}}{\partial {x}^{2}} ) .$$

Therefore, there is a need for improved computation technology that is able to calculate those second order sensitivities.

One area that is in need for improved computation technology that is able to calculate these second order sensitivities is in finance. In particular, the calculation of sensitivities of financial derivatives to changing market input data. These sensitivities, or Greeks, of financial derivatives (such as options) when priced using Monte-Carlo methods often exhibit instabilities. This unstable behaviour is most evident for second order Greeks (such as Gamma, Vomma) of financial derivatives with discontinuous payoffs.

Two alternative methods which result in unbiased estimates for Greeks are the path-wise method and the likelihood ratio method (LRM). The sensitivities under the path-wise method are obtained by differentiating the discounted payoff function, whilst in the case of the LRM, they are obtained through differentiating the probability density function (PDF).

One of the setbacks in using the path-wise method is that it requires taking the derivative of the discounted payoff, which formally requires the payoff to be a continuous function of the Greek parameter of choice. This is problematic for options that are not continuous, as is the case with digital options.

The LRM meanwhile does not suffer from the continuity requirement as the probability density function is assumed to be a smooth and differentiable function (i.e. a non-singular PDF). However, this method can have solutions coupled with a large variance, rendering it unusable in some cases. Another limitation is that it requires an explicit knowledge of the PDF.

Here, an extension of conventional Monte Carlo methods is disclosed, that can effectively generate stable Greek values for financial derivatives with discontinuous payoffs. This approach is independent from both the payoff functions and the stochastic models underlying the Monte-Carlo simulation.

This approach relies on smoothing the probability density function (PDF) generated by the Monte-Carlo simulation process for the price of the underlying asset. The price of the underlying asset may also be referred to as the underlying spot price, asset price or spot price. Smoothing functions such as polynomials and cubic splines can be used to fit the density functions satisfactorily for different asset price processes (models) under consideration. Once the smoothing function is chosen, it can be fitted to the different density profiles numerically generated from the Monte-Carlo simulations of shifted model parameter values corresponding to each type of Greek. Standard finite-differencing is then used to produce the corresponding Greek values. Numerical results of stable Greek values are provided in this disclosure to demonstrate the effectiveness of adopting this approach in Monte-Carlo methods for computing Greek values of financial derivatives with discontinuous payoffs.

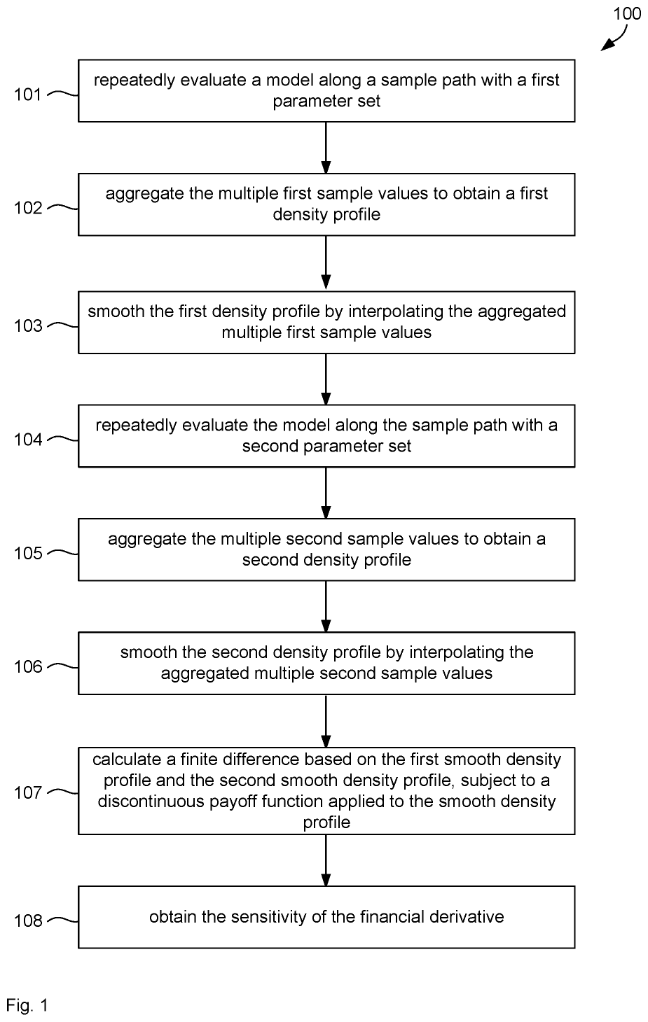

FIG. 1 illustrates a method 100 for computationally efficient calculation of a sensitivity of a financial derivative. A sensitivity is the change of a financial derivative with respect to changes of input market data. A financial derivative may be any type of financial instrument. An example of a financial instrument is an option, which is a contract between two parties that provides the holder with financial insurance on an investment. Options can be bought and sold at a varying price, so understanding how the option price changes with respect to changes of input market data is important for investors looking to protect their investments. Sensitivities of the option price are quantified through these financial derivative and often termed as ‘Greeks’ or ‘Greek values’, with each Greek corresponding to the financial derivative with respect to a different input market data value. As an example, the input market data can be the asset spot price, interest rate or volatility of the market. Nothing in this discussion is intended to limit financial derivative as options, however the options embodiment provides a ready illustration of the disclosed systems and methods. Further, the disclosed method is not limited to applications in the financial sector and may be used in areas such as engineering, physics or mathematics.

Method 100 begins by repeatedly evaluating 101 a model along a sample path with a first parameter set to obtain multiple first sample values. The sample path represents the evolution of the price of the underlying asset from an initial time to a final time. That is, the sample path outputs a price of an underlying asset. This final time is known as the time at maturity. Evaluating the model along the sample path may comprise using a stochastic model based on the parameters in the first parameter set. For example, the stochastic model may be the Geometric Brownian Motion model as known as the Black-Scholes model or the Heston model. These models rely on input market data such as the initial price of the underlying asset, the risk free interest rate, the dividend rate and the volatility. The output of evaluating the model along the sample path is a first sample value and repeating the evaluation of the model results in multiple first sample values. Each of the multiple first sample values is indicative of the price of the underlying asset at the time of maturity.

Method 100 then involves aggregating 102 multiple first sample values to obtain a first density profile. For example, the first density profile is a probability density function (PDF) and its independent variable is the price of the underlying asset at the time of maturity. Further, integrating this function between two output parameter values gives the probability that the asset price at maturity is between these two values. In an embodiment, aggregating 102 the multiple first sample values to obtain a first density profile comprises dividing a range of the multiple first sample values into intervals and counting a number of the multiple first sample values in each interval. The PDF therefore becomes a histogram representing the counts of each of the multiple first sample values in each interval.

As the PDF is typically discrete, method 100 further comprises smoothing 103 the first density profile by interpolating the aggregated multiple first sample values using a parameterised interpolation function to obtain a first smooth density profile. Therefore, the PDF becomes continuous by interpolating the values between the multiple first sample values. As a result, the first smooth density profile is also a function with respect to the price of the underlying asset.

In an embodiment, dividing a range of the multiple first sample values into intervals further comprises interpolating a frequency of the multiple first sample values occurring at the average of each interval. Because of the variation of the frequency count, an accurate representation of the distribution of the multiple first sample values is obtained by counting the frequency at the average of each interval. The frequency count at the average of each interval becomes the basis of the interpolation by a parameterised interpolation function. The frequency count at the average of each interval may also be referred to as interpolation points or ‘knots’.

Smoothing 103 the density profile has many computational and numerical advantages in applications in, but not limited to, engineering, physics, statistics and finance. Smoothing 103 the density profile is practically advantageous in the numerical calculation of definite integrals that integral over PDFs. Integrals over ‘well-behaved’ functions (smooth and continuous) converge much easier and faster. This provides a computational advantage as computational time to obtain convergence is reduced and less data memory, such as RAM or hard-drive storage, is required. Therefore, one can easily apply numerical integration techniques such as Gaussian-Legendre quadrature rules. Gaussian-Legendre quadrature rules are standard in mathematical packages for common programming languages, making it easily to implement in program development.

Further, smoothing 103 the density profile in Monte Carlo simulations mimics the simulation as if an infinite number of sample values were used. This provides the advantage of needing much less samples as compared to standard Monte Carlo PDF methods. Mimicking an infinite number of samples also allows the stable calculation of the sensitivities of the financial derivatives. It also provides a computational advantage as computational time to less data memory, such as RAM or hard-drive storage, is needed to store the sample values.

Method 100 then comprises repeatedly evaluating 104 the model along the sample path with a second parameter set to obtain multiple second sample values. Step 104 follows the similar procedure in step 102 using the second parameter set as opposed to the first parameter set. Then, the method comprises aggregating 105 the multiple second sample values to obtain a second density profile. Step 105 follows the similar procedure in step 103 using the multiple second sample values as opposed to the multiple first sample values. This is followed by smoothing 106 the second density profile by interpolating the aggregated multiple second sample values using the parameterised interpolation function to obtain a second smooth density profile. Step 106 follows the similar procedure in step 104 using the aggregated multiple second sample values as opposed to the aggregated multiple first sample values.

In most aspects, the second smooth density profile shares the same properties as the first smooth density profile. As one example, similar to the first smooth density profile, the second smooth profile is also a function of the price of the underlying asset. However, the main difference is that the first smooth density profile is obtained using the first parameter set and the second density profile is obtained using the second parameter set.

It is noted that the first parameter set and the second parameter set are perturbed relative to one another in at least one parameter. For example, the first parameter set may comprise a parameter that is perturbed by adding an incremental change to the parameter. The second parameter set is then perturbed relative to the first parameter set by perturbing the corresponding parameter in the second parameter set. In this example, the second parameter set is perturbed by subtracting the incremental change of the parameter from the parameter in the second parameter set. Therefore, it is possible that only the first parameter set or only the second parameter set or both are perturbed.

Lastly, method 100 involves calculating 107 a finite difference based on the first smooth density profile and the second smooth density profile, subject to a discontinuous payoff function applied to the smooth density profile, to obtain 108 the sensitivity of the financial derivative with respect to the at least one parameter. Calculating 107 the finite difference may also comprise subtracting the first smooth density profile from the second smooth density profile. Additionally, calculating 107 the finite difference may further comprise dividing the result of this subtraction by the incremental change in the parameter used to perturb the first and second parameter sets. Calculating 107 the finite difference gives a rate of change (derivative) of the financial derivative with respect to the at least one parameter. This rate of change of the financial derivative is indicative of the ‘Greek’ values mentioned previously.

The sensitivity of the financial derivative is stable as a result of smoothing the density profiles in steps 103 and 106 in method 100. Similar to integrals, numerical derivatives converge much easier and faster when differentiating a ‘well-behaved’ function. This also has the computational advantage of reduced computational time due to faster convergence and the requirement of less data memory.

Options can be considered as either a call option or a put option. Call options are financial contracts that give the option buyer the right but not the obligation to buy a stock, bond, commodity, or other asset or instrument at a specified price within a specific time period. This specified price is often called the strike price K and is set when the option is created. The time at the end of the specific time period, in which an option is valid, is often called the time at maturity T. A put option (or “put”) is a contract giving the option buyer the right, but not the obligation, to sell—or sell short—a specified amount of an underlying security at a predetermined price within a specified time frame.

A discontinuous payoff function (or simply a discontinuous payoff) is a function of the price of the underlying asset that gives the potential payoff of a particular function. For example, the payoff function for a European style vanilla call option is the maximum between the underlying asset price S at maturity T subtracted by the strike price K and zero, i.e. ƒ_{call}=max {S(T)−K,0}. Therefore, the potential payoff or potential profit is S(T)−K. By definition, the discontinuous payoff functions are discontinuous at the strike price, meaning they have a ‘kink’ at the strike price. In a mathematical sense, the payoff function is continuous at the strike price, but the first derivative of the payoff is not continuous with respect to asset price.

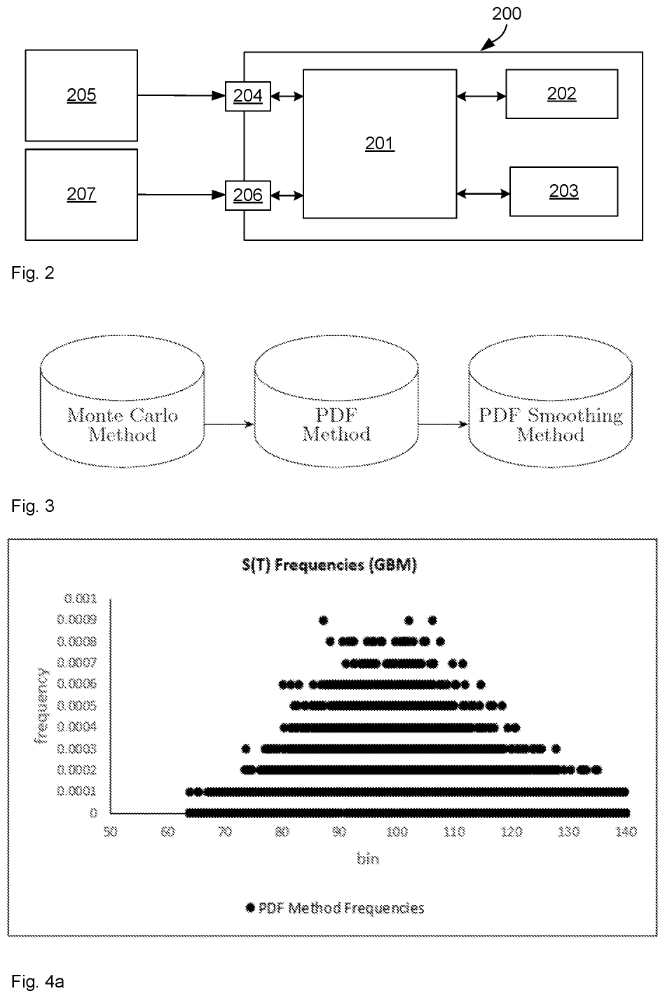

FIG. 2 illustrates a computer system 200 for computationally stable calculation of a sensitivity of a financial derivative. The computer system 200 comprises a processor 201 connected to a program memory 202 and a data memory 203. The program memory 202 is a non-transitory computer readable medium, such as a hard drive, a solid state disk or CD-ROM. Software, that is, an executable program stored on program memory 202 causes the processor 201 to perform the method in FIG. 1, that is, processor 201 repeatedly evaluates a model along a sample path with a first parameter set, aggregates the multiple first sample values to obtain a first density profile, smooths the first density profile by interpolating the aggregated multiple first sample values, repeatedly evaluates the model along the sample path with a second parameter set, aggregates the multiple second sample values to obtain a second density profile, smooths the second density profile by interpolating the aggregated multiple second sample values, calculates a finite difference based on the first smooth density profile and the second smooth density profile, subject to a discontinuous payoff function applied to the smooth density profile and obtains the sensitivity of the financial derivative.

The processor 201 may then store the sensitivity of the financial derivative on data memory 203, such as on RAM or a processor register. Processor 201 may also send the sensitivity of the financial derivative, the output parameter samples or the input parameter samples, via communication port 204 to a server, such as an internet server 205.

The processor 201 may also display the sensitivity of the financial derivative on a monitor 207 via an input/output port 206. The processor 201 may perform method 100 multiple times to calculate a multiple of sensitives, corresponding to financial derivatives with respect to different input market values.

Software may provide a user interface that can be presented to the user on a monitor 207. The user interface is configured to accept input from the user, via a touch screen or a device attached to monitor 207 such as a keyboard. The user input is provided to the input/output port 206 by the monitor 207. The sensitivity of the financial derivate may be received from data memory 203 by the processor 201 and displayed on monitor 207. Due to the efficiency of method 100 in calculating the sensitivity of the financial derivative, the sensitivities can by displayed on the monitor 207 in real time after the processor 201 receives the input market data from either the internet server 205 connected to the processor via the communications port 204, or user input provided to the input/output port 206. As processor 201 is in communication with an internet server 205, the processor may monitor the input market data in real time and efficiently calculate the sensitivity of the financial derivative of the input market data being updated on the internet server 205. This enables continual, real-time monitoring of the sensitivities by computer system 200.

The processor 201 may receive data through all these interfaces, which includes memory access of volatile memory, such as cache or RAM, or non-volatile memory, such as an optical disk drive, hard disk drive, storage server or cloud storage. The computer system 200 may further be implemented within a cloud computing environment, such as a managed group of interconnected servers hosting a dynamic number of virtual machines.

It is to be understood that any receiving step may be preceded by the processor 201 determining or computing the data that is later received. For example, the processor 201 calculates the sensitivity of the financial derivative and stores the sensitivity of the financial derivative in data memory 203, such as RAM or a processor register. The processor 201 then requests the data from the data memory 203, such as by providing a read signal together with a memory address. The data memory 203 provides the data as a voltage signal on a physical bit line and the processor 201 receives the sensitivity of the financial derivative via a memory interface.

FIG. 1 is to be understood as a blueprint for the software program and may be implemented step-by-step, such that each step in FIG. 1 is represented by a function in a programming language, such as C++ or Java. The resulting source code is then compiled and stored as computer executable instructions on program memory 202.

It is noted that for most humans performing the method 100 manually, that is, without the help of a computer, would be practically impossible. Therefore, the use of a computer is part of the substance of the invention and allows performing the necessary calculations that would otherwise not be possible due to the large amount of data and the large number of calculations that are involved.

In some embodiments, processor 201 may contain multiple computing units, where each computing processing units (CPUs) possesses multiple computing cores or threads. Processor 201, therefore, may be part of a high-performance computing (HPC) system. The HPC system may be locally available or remotely available such as the Pawsey Supercomputing Centre or Amazon Web Service (AWS). As a result, one or more aspects of the computer-implemented method 100 may be performed in parallel. Method 100 is easily able to be implemented in a parallel computing setting, which enables rapid computation times. For example, different values of the fitted parameterised function may be calculated in parallel across many CPUs and multiple cores, allowing for fast and efficient calculation of the finite difference.

In some embodiments, one Greek value can be calculated on a single core of single CPU. Therefore, multiple Greek values may be calculated on a single multi-core CPU. Likewise, multiple Greek values may be calculated on a single computing core across multiple CPUs. However, to maximise computational resources and computational efficiency, multiple computing cores should be used when using multiple CPUs. For example, a single Greek value may be calculated on a single CPU efficiently by multi-platform shared-memory parallel programming, such as OpenMP, which utilises the multiple computing cores of the CPU. Therefore, multiple Greek values may be calculated by utilising the full available computing architecture. However, if only one Greek value is desired, this Greek value may be efficiently calculated using many multi-core CPUs by distributing the calculation across the many CPUs and multiple cores in each CPU. Using many CPUs in this way may be performed through a message passing interface implementation such as OpenMPI.

In some embodiments, processor 201 may contain one or more graphical processing units (GPUs) such as an Nvidia RTX unit. Certain GPUs (particular NVidia GPUs) allow for highly efficient and fast linear algebra operations to be performed such as matrix multiplication. For example, for highly efficient and fast linear algebra operations may be performed on GPUs that support NVidia's Compute Unified Device Architecture (CUDA).

The method 100 for calculating the sensitivity of financial derivative allows computational elements such as different values of the fitted parameterised function to be organised as a linear algebra structure, such as a column vector or a matrix. Calculating multiple Greek values may be performed by creating a matrix of different values of the fitted parameterised function for different input market data values and matrix multiplying this matrix by a matrix containing the values of the discontinuous payoff function. Storing these computational elements as linear algebra structures allows for easy storage on data memory 203 and efficient recall by the program for subsequent calculations. Operations of these linear algebra structures can also be performed with high efficiency by utilising the CUDA on a GPU as part of processor 201.

### Underlying Asset Stochastic Models

The disclosed method is based on Monte-Carlo PDF methods and smoothing the final PDF where payoff function is evaluated. In the disclosed method, the PDF is found by using an approximating and smooth function to represent the frequency of the simulated prices of the underlying asset. The simulated asset prices can follow any stochastic dynamics. That is, any stochastic model may be used by processor 201 to evaluate a model along a sample path. The sample path represents the simulated prices of the underlying asset. Therefore, the disclosed method does not require any explicit knowledge of the PDF and can be applied to any model: i.e. is model independent. To demonstrate the effectiveness of the disclosed method, two stochastic models are used as the underlying dynamics for illustration purposes only, namely, the Geometric Brownian motion (GBM) model and the Heston stochastic volatility model. The choice of these two models is due to the fact that they have analytic solutions which can be used to benchmark the accuracy and robustness of using the disclosed method for computing second-order Greeks. However, the methodology is not limited to these models only. The new methodology can be used in pricing various options whose underlying dynamics are described by any mathematical models.

### GBM Model

Let S(t) be the price of an underlying dividend paying asset at time t, and W(t) be a Wiener process (W(t):N(1,0)) on which S(t) depends. Wiener process is a real valued continuous-time stochastic process that can be used to drive the GBM and Heston models. Under the risk-neutral process, the underlying price process follows a Geometric Brownian motion:

$$dS ( t ) = ( r - q ) S ( t ) dt + σ S ( t ) d W ( t ) , \qquad ( 1 )$$

where r is the risk free interest rate, q is the dividend rate and σ is the constant volatility. Since the disclosed method uses Monte Carlo simulation in which the computations are done over different time steps [t₀, . . . , t_{N}_{_{T}}], where dt=tᵢ₊₁−tᵢ, the continuous time process is discretized using Euler discretization as below:

$${S}_{i + 1} = {S}_{i} + ( r - q ) {S}_{i} Δ t + σ {S}_{i} \sqrt{Δ t {ò}_{i}} . \qquad ( 2 )$$

Alternatively, Ito's lemma could be used to obtain a closed form solution to Equation 1 in continuous form and is given as:

$${S}_{t} = {S}_{0} exp ( ( r - q - \frac{{σ}^{2}}{2} ) Δ t + σ {W}_{t} ) , \qquad ( 3 )$$

On discretising this equation:

$${S}_{i + 1} = {S}_{i} exp ( ( r - q - \frac{{σ}^{2}}{2} ) Δ t + σ \sqrt{Δ t} {ε}_{i} ) , \qquad ( 4 )$$

where εᵢ is a standard normal deviate.

### Heston Model

One of the assumptions of the GBM model is that volatility is constant. Since financial data indicates otherwise, the Heston model seeks to capture this by assuming that the volatility is stochastic. That is, the volatility may be variable with respect to time. If the volatility varies with respect to time, then its evolution in time must also be modelled simultaneously to the price of the underlying asset. The Heston stochastic volatility model can be described by the following square root model:

$$dS ( t ) = ( r - q ) S ( t ) dt + \sqrt{σ ( t )} S ( t ) d {W}_{1} ( t ) \qquad ( 5 )$$

$$d σ ( t ) = κ ( θ - σ ( t ) ) dt + {σ}_{v o l} \sqrt{σ ( t )} d {W}_{2} ( t )$$

where t, S(t), r and q are defined similarly as in the GBM model. W₁(t) and W₂(t) are correlated Wiener processes where [symbol] dW₁, dW₂ [symbol] =ρdt, σ(t) is a stochastic variance, κ is the rate of mean reversion, θ is the long run mean of σ(t) and σᵥₒₗ is the volatility of σ(t). Since in this bivariate system W₁ and W₂ are assumed to be correlated with correlation factor ρ, a Cholesky decomposition is used to obtain an equivalent system of independent Brownian motions. Thus, W₂=Z₂ and W₁=ρZ₂+\sqrt{1−ρ²}Z₁. Hence the transformed system of equations is

$$dS ( t ) = ( r - q ) S ( t ) dt + \sqrt{σ ( t )} S ( t ) ( ρ d {Z}_{2} + \sqrt{1 - {ρ}^{2}} d {Z}_{1} ( t ) ) \qquad ( 6 )$$

$$d σ ( t ) = κ ( θ - σ ( t ) ) d t + {σ}_{v o l} \sqrt{σ ( t )} d {Z}_{2} ( t )$$

This system of equations is in continuous form. Similar to the GBM model, this bi-variate model is discretized using an Euler discretization:

$${S}_{i + 1} = {S}_{i} + ( r - q ) {S}_{i} Δ t + \sqrt{{σ}_{i}} {S}_{i} ( ρ \sqrt{Δ t} {ó}_{i} + \sqrt{1 - {ρ}^{2}} \sqrt{Δ t} {δ}_{i} ) \qquad ( 7 )$$

$${σ}_{i + 1} = {σ}_{i} + κ ( θ - {σ}_{i} ) Δ t + {σ}_{vol} \sqrt{{σ}_{i}} \sqrt{Δ t} {ó}_{i}$$

As can be seen from the above Heston model, the volatility is a variable that is simultaneously evaluated in the model when the asset price sample path is generated. That is, the volatility and the price of the underlying asset are simultaneously modelled together, as the change in the asset price is dependent on the change of the volatility.

### A Monte-Carlo Method Using Smoothed PDF

European style vanilla and digital options are used as example cases to demonstrate the effectiveness of the disclosed method for computing option prices and corresponding Greeks. The underlying price process S(t) follows either the GBM model or the Heston Model as an example. However, the disclosed method is not limited to using the GBM or Heston model to simulate the price of the underlying asset. The GBM and Heston models have close form (analytic) solution results and can be used as benchmark to quantify and demonstrate accuracy of the disclosed method.

The price of an option is defined as the discounted expected value of the payoff function ƒ(S,t) under the risk neutral measure R. Mathematically:

$$\begin{matrix}{E}_{option} = {E}^{R} [ {e}^{- rT} f ( S , t ) ] \\ = {\int }_{0}^{∞} {e}^{- rt} f ( S , t ) \times g ( S ( T ) ) dS\end{matrix} \qquad ( 8 )$$

where T is the time at maturity. The integral equation is normally implemented through a standard Monte-Carlo simulation method in this form:

$${E}_{option} = \frac{1}{{N}_{S}} {\sum }_{i = 1}^{{N}_{S}} [ {e}^{- rT} f ( S , t ) ] \qquad ( 9 )$$

where r is the risk-free interest rate and g(S) is the PDF of S(t). N_{S} is the number of simulations when a standard Monte-Carlo method is used.

The payoff functions for a European style vanilla option is:

$${f}_{call} ( S ( T ) ) = max [ S ( T ) - K , 0 ] \qquad ( 10 )$$

$${f}_{put} ( S ( T ) ) = max [ K - S ( T ) , 0 ] \qquad ( 11 )$$

For a European style digital option, the payoff function is:

$${f}_{call} ( S ( T ) ) = \{ \begin{matrix}1 , & if S ( T ) > K \\ 0 , & if S ( T ) <= K\end{matrix} . \qquad ( 12 )$$

$${f}_{put} ( S ( T ) ) = \{ \begin{matrix}1 , & if S ( T ) <= K \\ 0 , & if S ( T ) > K\end{matrix} \qquad ( 13 )$$

Computing option prices under the integral form in Equation 8 uses a PDF g(S). For models like the GBM and Heston models, this PDF is available in closed form solution, meaning that an analytic expression of the PDF is obtainable. Therefore, the results of the disclosed method may be compared to the exact analytic solution to observe the effectiveness of smoothing the PDF. However, more sophisticated models commonly used in the industry do not have an explicit PDF that can be expressed or known in analytic form. The disclosed method is generic and model free when estimating the PDF in Equation 8, which makes it an effective method used in the industry. FIG. 3 illustrates the development steps of the disclosed methodology. While this disclosure puts an emphasis on smoothing the PDF in a financial setting, the method can be used in a variety of other industries such as physics, mathematics and engineering.

Standard Monte-Carlo Method in brief: For the Monte Carlo method, the price process [S(t)] (GBM model) and [σ(t), S(t)] (Heston Model) are simulated from the initial time to maturity T. The asset price at T for each path is then retained. This process is repeated for N_{S} simulations and the payoff which depends on S(T) is computed per simulation. The option price is obtained by averaging over these payoffs and discounting the result, as described by Equation 9.

Standard PDF method in brief: The implementation of the PDF method utilises the N_{S} simulated values at maturity obtained through the standard Monte Carlo process. The maximum and minimum value of the N_{S} simulated values is determined. Equal sized partitioning of the space between the maximum and minimum price values are created and the equal sized intervals are sometimes called bins and interval length is often referred as the bin size. The number of S(T) values falling within each of these intervals are counted as frequencies against the total number of bins N_{b}. The average of each interval or bin is used for computation purposes in place of the continuous S(T). The option price is then computed as the sum of the product of the frequency corresponding to each interval and the payoff. The summation is over the total number of bins. Therefore, the option price is written as:

$${C}_{Option} = {e}^{- rt} {\sum }_{i = 0}^{{N}_{b}} ( f ( \frac{{S}_{i + 1} + {S}_{i}}{2} ) \times {Frequency}_{i} ) \qquad ( 14 )$$

where

$${N}_{b} = \frac{{S ( T )}_{max} - {S ( T )}_{min}}{binsize}$$

As the proposed bin size approaches zero, the PDF method approaches the Monte Carlo method values. Hence the two methods are expected to perform similarly for a bin size that is small enough. Thus the strengths and the weaknesses of the Monte Carlo method are similar to the PDF method.

Equivalently, in the disclosed method, the processor 201 aggregates the multiple first and second sample values to obtain a first and second density profile. The processor 201 calculates two density profiles (a first and second) as at least two density profiles are needed to calculate the sensitivity of the financial derivative. The multiple first and second sample values correspond to the multiple values of the asset price at the time of maturity that are determined through modelling the asset price. The multiple first sample values are used to calculate a first density profile and the multiple second sample values are used to calculate the second density profile. Processor 201 then divides a range of the multiple first and second sample values into intervals and counting a number of the multiple first and second sample values in each interval. These intervals are equivalent to the bins described above and the bin size is equivalent to the size of the intervals.

As in the Monte Carlo method, when the number of simulations is limited, the PDF is non-smooth and as the number of simulations is increased, the PDF will then become smooth and converge to the true PDF as the number of simulations tends to infinity. The non-smoothness in the PDF when combined with discontinuous payoff functions can create slight instabilities in option prices which then can translate into unstable Greek values particularly for second-order sensitivities.

The disclosed method addresses this issue by using an interpolation function to smooth the computed PDF. Essentially, the smoothed PDF can be viewed as more closely representing the PDF if the number of Monte-Carlo simulations is infinite. That is, smoothing the PDF has the advantage of mimicking the simulation if an infinite number of simulations were used. In the disclosed method, processor 201 smooths the first and second density profile using a parameterised interpolation function. For example, the parameterised interpolation function may be a polynomial or cubic splines. In an example, processor 201 may acquire the parameterised interpolation function by accessing the GNU Scientific Library (GSL) or equivalent. The GNU Scientific Library (GSL) is a numerical library for C and C++ programmers and free software under the GNU General Public License (https://www.gnu.org/software/gsl/). The library provides a wide range of mathematical routines such as random number generators, special functions and least-squares fitting. There are over 1000 functions in total with an extensive test suite.

Consequently, the option prices thus computed can expect to be more robust for payoff functions with discontinuities even when the number of Monte-Carlo simulations is not large, and subsequent computation for Greek values are expected to be stable. The processor 201 may smooth the first and second density profile by interpolating a frequency in each of the intervals. In an embodiment, the frequency may be the count of the number of multiple sample values that occur at the average of the interval. In this embodiment, the average provides the best interpolation points or ‘knots’ for the parameterised interpolation function due to the variation of the multiple first and second sample values.

The algorithmic steps of the PDF method and the disclosed method under both the GBM and the Heston models as examples of implementing this method are provided below. Either of the methods below can be performed by processor 201 to obtain a smooth density profile.

Implementing smoothed PDF method for GBM model
1. Generate N_{T} random variables for the 1^{st} simulation (ò_{1,1}, ò_{1,2}, . . . , ò_{1,N}_{_{T}}) with N_{T} time steps.
2. Using these generated random variables, simulate S using Equation 2 until the final time step.
3. Repeat Step 1 and Step 2 N_{S} times, thus giving us N_{S} values of S(T).
4. For the N_{S} simulated values of S(T), obtain the maximum (Sₘₐₓ) and the minimum (Sₘᵢₙ) values of this set of values to determine the range at which frequencies are computed.
5. Select a bin size for the frequencies to determine the intervals.
6. Compute the frequencies at each of the intervals [Sⱼ, Sⱼ₊₁].

$$7. Compute the \% frequency = \frac{frequency}{{N}_{S}} .$$

8. Compute the average of each interval [Sⱼ, Sⱼ₊₁]. This value would be used as the reference point for all the computations:

$${S}_{Average , j} = \frac{{S}_{j + 1} + {S}_{j}}{2}$$

9. The % frequencies corresponding to S_{Average,j}, are the used in pricing options using the PDF method.
10. Fit a smooth curve to the frequency data using cubic spline interpolation. The resulting frequencies obtained from the smoothing procedure would be the used in pricing options using the disclosed method.
11. Using the original frequencies (PDF Method) or approximated frequencies (PDF Smoothing method) compute the option price using Equation 14 with the payoff selection depending on the option type.

Implementing smoothed PDF method for Heston model.
1. Generate two sets of N_{T} random variables (ò_{1,1}, ò_{1,2}, . . . , ò_{1,NT}), (δ_{1,1}, δ_{1,2}, . . . , δ_{1,NT}) for the 1^{st} simulation with N_{T} time steps.
2. Transform these two sets of N_{T} random variables (òᵢⱼ and δᵢⱼ) from being correlated to being independent random variables using Cholesky decomposition. The transformation is as follows:

$${W}_{2} = {δ}_{i} \qquad ( 15 )$$

$${W}_{1} = {ρδ}_{i} + \sqrt{1 - {ρ}^{2}} {ó}_{i} \qquad ( 16 )$$

3. Simulate σᵢ₊₁ using the random variable in Equation 15 and the second line of Equation 7 up to the last step N_{T} at maturity. Whenever σᵢ₊₁ is less than zero, the value is floored at zero since negative numbers are not valid for variance.
4. Using σᵢ₊₁, Equation 15 and Equation 16, simulate Sᵢ₊₁ using the first line of Equation 7 up to the last step N_{T} at maturity, the value S(T) is obtained.
5. Repeat the above steps 1-4 for N_{S} simulations. This results in N_{S} values of S(T).
6. Next, proceed as in steps 4-11 in the algorithm for the GBM model.

The major advantage of the disclosed method is that it can be applied simply and directly to any payoff function and any underlying dynamics without the need for altering the algorithm. In other words, the payoff function may be continuous or discontinuous and any model can be used to simulate the price of the underlying asset. The fact that any type of payoff function may be used is an advantage that makes the disclosed method applicable to a variety of different disciplines. In the mathematical finance field, the financial derivative is not limited to option prices and thus, may have payoff functions that are continuous rather than discontinuous. Further, using a discontinuous payoff function in standard Monte Carlo PDF methods leads to unstable sensitivities, whereas the disclosed methods produce stable sensitivities. Stability of the sensitivities can be considered as smooth and continuous with respect to changing values of input market data or parameters of the financial derivative such as the strike price. Unstable sensitivities generally indicate the accuracy of calculated Greek values are prone to random impact and unreliable. More importantly, unstable sensitivity values (Greek values) can render impossible the hedging of risks for trading books.

Processor 201 performs the above smoothed PDF methods at least twice to obtain at least one sensitivity of the financial derivative. Processor 201 performs the above methods twice in order to calculate a first smooth density profile and a second smooth density profile. Each time processor 201 performs the method, a different set of parameters are fixed during the process. For example, a first parameter set may be used to calculate the first smooth density profile and a second parameter set may be used to calculate the second smooth density profile. Each of the first parameter set and the second parameter set may comprise one or more of initial price of the underlying asset, risk free interest rate, dividend rate and volatility. If the model used to simulate the asset price uses a constant volatility, such as the GBM model, then the value of the volatility is fixed at the start of the process. However, if the volatility is not constant, that is, if the volatility is stochastic or is variable in time, then the initial fixed volatility is used in the parameter set. This fixed initial volatility is equivalent to \sqrt{σ₀} that is seen in Equation 7.

Before performing the above methods, the first parameter set and the second parameter set are perturbed relative to one another in at least one parameter. As an example, the at least one parameter may be the risk free interest rate r. In this example, one might set r to be 0.03 and perturbing this parameter in the first parameter set comprises adding an incremental change Δ to r=0.03. The incremental change Δ may be relativity small in comparison to the value of the parameter. For example, the incremental change Δ may be 0.0001, which is relatively small compared to 0.03. Therefore, by perturbing this parameter in the first parameter set, the risk free interest rate will be 0.0301. By perturbing the second parameter set relative to the first parameter set, the same incremental change Δ is used to perturb by the same parameter in the second parameter set. For example, if the parameter in the first parameter set is perturbing by adding the incremental change Δ, the parameter in the second parameter set may be perturbed by subtracting the incremental change Δ. Therefore, by perturbing this parameter in the second parameter set, the risk free interest rate will be 0.0299.

### Computing the Greeks

When the PDF of the underlying asset price is known in closed form, it can be possible to also find closed form formulae for the option price and Greeks, where the Greeks can be computed by finding analytical formula for first, second or third order derivatives of the option pricing formulae with respect to the parameters of interest. Using the GBM and Heston models to simulate the underlying asset price, the PDF can be obtained in a closed form. However, it is often the case that closed form formulae for the PDF and option prices cannot be found for asset dynamic models that are more commonly used in the industry.

Similarly to the LRM, Greeks computed using the disclosed method are obtained by computing derivatives of the PDF, however, the derivatives of the PDF are generated by finite-differencing of the smooth PDFs with respect to the parameters of interest (e.g., spot price, volatility etc.) and hence the computation of the derivatives is normally achievable. One of the advantages of this methodology is that it does not require an explicit knowledge of the PDF, and this is one of the limitations in using the LRM. The disclosed method only uses the knowledge of the path simulated through any asset model. The functional form of the payoff function does not impact the computation of Greeks, and hence this method provides a good alternative to path-wise methods which requires the payoff function to be continuous. Similarly to Equation 8, the option price is given by

$${C}_{option} = {\int }_{0}^{∞} {e}^{- rT} \times f ( S , t ) \times g ( S , σ , t , r ) dS . \qquad ( 17 )$$

To obtain a sensitivity of a financial derivative, processor 201 calculates 107 a finite difference based on the first smooth density profile and the second smooth density profile, subject to a discontinuous payoff function applied to the smooth density profile. Though the processor 201 calculates the finite difference based on the first smooth density profile and the second smooth density profile, calculating the finite difference may include additional elements needed for the calculation. In an example, an additional smooth density profile is obtained using the disclosed method and used by the processor 201 to calculate the finite difference. In another example, calculating the finite difference may additionally include a factor such as 2\sqrt{σᵥₒₗ}.

In an example, processor 201 evaluates the first smooth density profile, the second smooth density profile and the discontinuous payoff function at the average of each interval. These intervals correspond to the bins that were described earlier.

To calculate the finite difference, the processor 201 performs a subtraction of the first smooth density profile from the second smooth density profile. The first and second smooth density profiles are calculated using a first and second parameter set respectively. The first parameter set and the second parameter set are perturbed relative to one another in at least one parameter using incremental change Δ in the at least one parameter.

Processor 201 uses the subtraction of the first and second density profile by dividing it by the incremental change Δ. This subtraction and the division may be known as a difference quotient. This division may also be a division by the incremental change Δ up to a factor. For example, if the sensitivity of the financial derivative corresponds to a first order derivative, the division by the incremental change Δ may be up to a factor of 2. More specifically, the difference quotient comprises the subtraction of the first and second smooth parameter functions divided by 2Δ. In another example, if the sensitivity of the financial derivative corresponds to a first order derivative, the division by the incremental change Δ may be up to a factor of 4.

The at least one parameter may be indicative of one or more of the underlying asset price, the risk free interest rate, the dividend rate and the volatility. In the embodiment where the financial derivative is an option price, the sensitivity of the financial derivative is the rate of change of the option price with respect to the at least one parameter. In this embodiment, the sensitivity is a Greek value, where each of the derivative with respect to a different parameter are given a unique ‘Greek’ name. For example, the sensitivity with respect to the risk free interest rate r is named “Rho”. In other words, the derivative of the option price with respect to the risk free interest rate r is named “Rho”.

In an embodiment, the sensitivity of the financial derivative may be with respect to the price of the underlying asset S. In this embodiment, the initial asset price may be perturbed in the first and second parameter using an incremental change Δ equal to zero. Therefore, in this embodiment, the first and second parameter set are equivalent. However, even though the first and second parameter sets are equivalent, the first and second smooth density profiles would not be equivalent unless the random number processes are identically generated. This is because stochastic processes are used to calculate these smooth density profiles and repeating the modelling of the sample path results in different multiple sample values.

Further, in this embodiment, as the first and second density profiles are functions with respect to the underlying asset price, processor 201 perturbs the asset price to calculate the finite difference. In an example, the underlying asset price in the first smooth density profile is perturbed by adding an incremental change Δ. Similarly, the underlying asset price in the second smooth density profile is perturbed by subtracting the incremental change Δ. By perturbing the underlying asset price variable in the first and second smooth density profiles, processor 201 calculates the finite difference, despite the first and second parameter set being equivalent.

The first order Greeks which are of interest to us are Delta, Vega, Theta and Rho. These are computed as:

$$\begin{matrix}{C}_{Delta} = \frac{\partial {C}_{option}}{\partial S} = {\int }_{0}^{∞} {e}^{- rT} \times f ( S , t ) \times \frac{\partial g ( S , σ , t , r )}{\partial S} dS \\ = {\sum }_{i = 1}^{{N}_{b}} [ {e}^{- rT} f ( {S}_{i} , t ) \times \frac{{g}_{i} ( {S}_{i} + Δ S , σ , t , r ) - {g}_{i} ( {S}_{i} - Δ S , σ , t , r )}{2 \times Δ S} ]\end{matrix} \qquad ( 18 )$$

$$\begin{matrix}{C}_{Vega} = \frac{\partial {C}_{option}}{\partial σ} = {\int }_{0}^{∞} {e}^{- rT} \times f ( S , t ) \times \frac{\partial g ( S , σ , t , r )}{\partial σ} dS \\ = {\sum }_{i = 1}^{{N}_{b}} [ {e}^{- rT} f ( {S}_{i} , t ) \times \frac{{g}_{i} ( {S}_{i} , σ + Δ σ , t , r ) - {g}_{i} ( {S}_{i} , σ - Δ σ , t , r )}{2 \times Δσ} ]\end{matrix} \qquad ( 19 )$$

$$\begin{matrix}{C}_{Theta} = \frac{\partial {C}_{option}}{\partial t} = {\int }_{0}^{∞} f ( S , t ) \times \frac{\partial ( {e}^{- rT} \times g ( S , σ , t , r ) )}{\partial t} dS \\ = {\sum }_{i = 1}^{{N}_{b}} [ f ( {S}_{i} , t ) \times \frac{( {e}^{- r ( T + Δ t )} {g}_{i} ( {S}_{i} , σ , t + Δ t , r ) ) - ( {e}^{- r ( T + Δ t )} {g}_{i} ( {S}_{i} , σ , t - Δ t , r ) )}{2 \times Δ t} ]\end{matrix} \qquad ( 20 )$$

$$\begin{matrix}{C}_{Rho} = \frac{\partial {C}_{option}}{\partial r} = {\int }_{0}^{∞} f ( S , t ) \times \frac{\partial ( {e}^{- rT} \times g ( S , σ , t , r ) )}{\partial r} dS \\ = {\sum }_{i = 1}^{{N}_{b}} [ f ( {S}_{i} , t ) \times \frac{( {e}^{- ( r + Δ r ) T} {g}_{i} ( {S}_{i} , σ , t , r + Δ r ) ) - ( {e}^{- ( r + Δ r ) T} {g}_{i} ( {S}_{i} , σ , t , r + Δ r ) )}{2 \times Δ r} ]\end{matrix} \qquad ( 21 )$$

under the assumption that the order of integration and differentiation is interchangeable. The second order Greeks which are of interest to us are Gamma, Vomma and Vanna. They are computed as

$$\begin{matrix}{C}_{Gamma} = \frac{{\partial }^{2} {C}_{option}}{\partial {S}^{2}} = {\int }_{0}^{∞} {e}^{- rT} \times f ( S , t ) \times \frac{{\partial }^{2} g ( S , σ , t , r )}{\partial {S}^{2}} dS \\ = {\sum }_{i = 1}^{{N}_{b}} [ {e}^{- rT} f ( {S}_{i} , t ) \times \frac{{g}_{i} ( {S}_{i} + Δ S , σ , t , r ) - 2 {g}_{i} ( {S}_{i} , σ , t , r ) + {g}_{i} ( {S}_{i} - Δ S , σ , t , r )}{Δ {S}^{2}} ]\end{matrix} \qquad ( 22 )$$

$$\begin{matrix}{C}_{Vanna} = \frac{{\partial }^{2} {C}_{option}}{\partial S \partial σ} = {\int }_{0}^{∞} {e}^{- rT} \times f ( S , t ) \times \frac{{\partial }^{2} g ( S , σ , t , r )}{\partial S \partial σ} dS \\ = {\sum }_{i = 1}^{{N}_{b}} {e}^{- rT} f ( {S}_{i} , t ) \times \frac{{g}_{i} ( {S}_{i} + Δ S , σ + Δσ , t , r ) - {g}_{i} ( {S}_{i} + Δ S , σ - Δσ , t , r )}{4 ΔσΔ S} - \\ {\sum }_{i = 1}^{{N}_{b}} {e}^{- rT} f ( {S}_{i} , t ) \times \frac{{g}_{i} ( {S}_{i} - Δ S , σ + Δσ , t , r ) - {g}_{i} ( {S}_{i} - Δ S , σ - Δσ , t , r )}{4 ΔσΔ S} ,\end{matrix} \qquad ( 23 )$$

$$\begin{matrix}{C}_{Vomma} = \frac{{\partial }^{2} {C}_{option}}{\partial {σ}^{2}} = {\int }_{0}^{∞} {e}^{- rT} \times f ( S , t ) \times \frac{{\partial }^{2} g ( S , σ , t , r )}{\partial {σ}^{2}} dS \\ = {\sum }_{i = 1}^{{N}_{b}} [ {e}^{- rT} f ( {S}_{i} , t ) \times \frac{{g}_{i} ( {S}_{i} , σ + Δσ , t , r ) - 2 {g}_{i} ( {S}_{i} , σ , t , r ) + {g}_{i} ( {S}_{i} , σ - Δσ , t , r )}{{Δσ}^{2}} ] ,\end{matrix} \qquad ( 24 )$$

For the Heston model, one uses a formulation for Vega which is based on σ=\sqrt{σ₀}. σ₀ is the initial variance value at time t₀ that is part of the first and second parameter sets when using the Heston model. As a results, Vega, Vanna and Vomma are calculated in this way:

$$\begin{matrix}{C}_{Vega} = \frac{\partial {C}_{option}}{\partial σ} = \frac{\partial {C}_{option}}{\partial {σ}_{0}} 2 \sqrt{{σ}_{0}} = {\int }_{0}^{∞} {e}^{- rT} \times f ( S , t ) \times \frac{\partial g ( S , {σ}_{0} , t , r )}{\partial {σ}_{0}} 2 \sqrt{{σ}_{0}} dS \\ = {\sum }_{i = 1}^{{N}_{b}} [ {e}^{- rT} f ( {S}_{i} , t ) \times \frac{{g}_{i} ( {S}_{i} , {σ}_{0} + {Δσ}_{0} , t , r ) - {g}_{i} ( {S}_{i} , {σ}_{0} - {Δσ}_{0} , t , r )}{{Δσ}_{0}} \sqrt{{σ}_{0}} ] ,\end{matrix} \qquad ( 25 )$$

$$\begin{matrix}{C}_{Vanna} = \frac{{\partial }^{2} {C}_{option}}{\partial S \partial σ} = \frac{{\partial }^{2} {C}_{option}}{\partial S \partial {σ}_{0}} 2 \sqrt{{σ}_{0}} {\int }_{0}^{∞} {e}^{- rT} \times f ( S , t ) \times \frac{{\partial }^{2} g ( S , {σ}_{0} , t , r )}{\partial S \partial {σ}_{0}} 2 \sqrt{{σ}_{0}} dS \\ = {\sum }_{i = 1}^{{N}_{b}} {e}^{- rT} f ( {S}_{i} , t ) \times \frac{{g}_{i} ( {S}_{i} + Δ S , {σ}_{0} + {Δσ}_{0} , t , r ) - {g}_{i} ( {S}_{i} + Δ S , {σ}_{0} - {Δσ}_{0} , t , r )}{4 {Δσ}_{0} Δ S} 2 \sqrt{{σ}_{0}} - \\ {\sum }_{i = 1}^{{N}_{b}} {e}^{- rT} f ( {S}_{i} , t ) \times \frac{{g}_{i} ( {S}_{i} - Δ S , {σ}_{0} + {Δσ}_{0} , t , r ) - {g}_{i} ( {S}_{i} - Δ S , {σ}_{0} - {Δσ}_{0} , t , r )}{4 {Δσ}_{0} Δ S} 2 \sqrt{{σ}_{0}} ,\end{matrix} \qquad ( 26 )$$

$$\begin{matrix}{C}_{Vomma} = \frac{{\partial }^{2} {C}_{option}}{\partial {σ}^{2}} = \frac{\partial {C}_{vega}}{\partial {σ}_{0}} 2 \sqrt{{σ}_{0}} = 4 ( \frac{{\partial }^{2} {C}_{option}}{\partial {σ}_{0}^{2}} {σ}_{0} + \frac{1}{2} \frac{\partial {C}_{option}}{\partial {σ}_{0}} ) \\ = {\int }_{0}^{∞} {e}^{- rT} \times f ( S , t ) \times 4 \times ( \frac{{\partial }^{2} g ( S , {σ}_{0} , t , r )}{\partial {σ}_{0}^{2}} {σ}_{0} + \frac{1}{2} \frac{\partial g ( S , {σ}_{0} , t , r )}{\partial {σ}_{0}} ) dS \\ = {\sum }_{i = 1}^{{N}_{b}} [ {e}^{- rT} f ( {S}_{i} , t ) \times 4 \times \frac{{g}_{i} ( {S}_{i} , {σ}_{0} + {Δσ}_{0} , t , r ) - 2 {g}_{i} ( {S}_{i} , {σ}_{0} , t , r ) + {g}_{i} ( {S}_{i} , {σ}_{0} - {Δσ}_{0} , t , r )}{{Δσ}_{0}^{2}} {σ}_{0} ] + \\ {\sum }_{i = 1}^{{N}_{b}} [ {e}^{- rT} f ( {S}_{i} , t ) \times \frac{{g}_{i} ( {S}_{i} , {σ}_{0} + {Δσ}_{0} , t , r ) - {g}_{i} ( {S}_{i} , {σ}_{0} - {Δσ}_{0} , t , r )}{{Δσ}_{0}} ] ,\end{matrix} \qquad ( 27 )$$

As can be seen in the above equations, processor 201 calculates the finite difference by using the sum defined in Equation 14. In other words, processor 201 calculates a sum over each interval (or bin). In the equations above, Sᵢ is the average of each bin. More clearly, for a bin that is equivalent to the interval [Sⱼ, Sⱼ₊₁], the average of this interval is

$${S}_{i} = \frac{{S}_{j + 1} - {S}_{j}}{2} .$$

Thus, it can be seen during the process of calculating the finite difference, processor 201 evaluates the first and second smooth density profile and the discontinuous payoff function at the average of each interval.

### Numerical Results and Analysis

To analyze the numerical performance of this method, both vanilla and digital options under two different models are calculated for the underlying asset; a GBM model and the Heston model, as outlined above. For the GBM, S₀ is defined as the initial asset price, σ as the volatility, r as the risk free interest rate, q as the dividend rate and T as the maturity. For the Heston model, in addition to these parameters (except σ) is σᵥₒₗ the volatility of volatility, κ the rate of mean reversion, θ the long term mean of σ(t) and ρ the correlation between S and V. The parameter values are presented in Table 1. The Monte Carlo method is used to simulate each stochastic process, with N_{T} time steps and N_{S} number of simulations of normal random variables used. The Δ column represents the size of the small shifts applied on parameter values (up or down) when computing Greeks. The optimal bin size used, taking into account accuracy and time factors is 0.005 for the GBM model and 0.001/0.005 for the Heston model.

TABLE 1
Parameter values used in implementing the different models.

| Parameter | GBM Model | Heston Model | Δ |
|---|---|---|---|
| S₀ | 100 | 100 | 1.0 |
| r | 0.03 | 0.03 | 0.0001 |
| q | 0.03 | 0.02 | |
| T | 0.25 | 0.25 | 0.001 |
| σ | 0.25 | | 0.01 |
| V₀ | | 0.03 | 0.001 |
| σᵥₒₗ | | 0.5 | |
| κ | | 6.2 | |
| θ | | 0.06 | |
| ρ | | −0.7 | |
| N_{S} | 10000 | 10000 | |
| N_{T} | 200 | 200 | |
| Bin Size | 0.005 | 0.005/0.001 | |

By computing prices and Greeks for both vanilla and digital options in this case study, the efficacy of this disclosed method in generating stable second-order Greeks for both continuous and discontinuous payoff functions can be examined. The Greeks computed with the disclosed method are compared directly with the conventional Monte Carlo method, the PDF method without smoothing and the corresponding analytic method, as both the GBM (Black-Scholes) and Heston models admit closed form solutions. In some test cases, Greek values of the analytic method are obtained by perturbing the analytic formula and using finite differencing. The Greeks calculated are Delta, Vega, Theta, Rho, Gamma, Vanna and Vomma or Volga. Lastly, a comparison of the new disclosed method to the LRM method is made, with the analytic method as the benchmark, and the discussion around these results ensues.

### Standard PDF Method

When pricing options using the conventional Monte Carlo method, payoffs are computed path-wise, averaged over the number of simulations and discounted at the risk free interest rate to obtain the option price. The disclosed method focuses on constructing the PDF of the underlying through computing frequencies of the simulated asset values at maturity, instead of using the usual Monte Carlo sampling technique. In order to construct a PDF from the Monte Carlo samples of the underlying, the maximum and minimum values of all the simulated S(T) values for each simulation are obtained, with the range increased by a fixed amount to ensure that all sampled values are included across multiple simulations (for example, for different values of the initial spot price). This does not impact the results of the option price under this disclosed methodology since the frequencies in this added range will be zero. The representative value over each interval that is used for computational purposes is the average value over each specific interval. For a vanilla option, the payoff is obtained by finding the maximum of zero and the difference of the option strike from this simulated asset value at maturity. Having obtained the frequencies over each interval and the payoff, the option price is the discounted product sum of these two. It is noted that as the bin size approaches zero, the option price under this methodology approaches the Monte Carlo price.

For example, using the parameter values in Table 1, processor 201 computes the price of a call option under the Heston model when the strike price is 96 using the PDF method. Simulation is performed and for a set of 10000 S(T) values, the minimum value is 56.7936 and the maximum value is 137.5504. When the bin size is 0.005, the intervals are [56.7936, 56.7986],
[56.7986,56.8036], . . . , [137.5454,137.5504]. The percentage frequency of S(T) in each interval is determined. For computational purposes, the average of each interval is used as the representative point for S(T), i.e. 56.7961 for the first interval, 56.8011 for the second interval . . . and 137.5479 for the last interval.

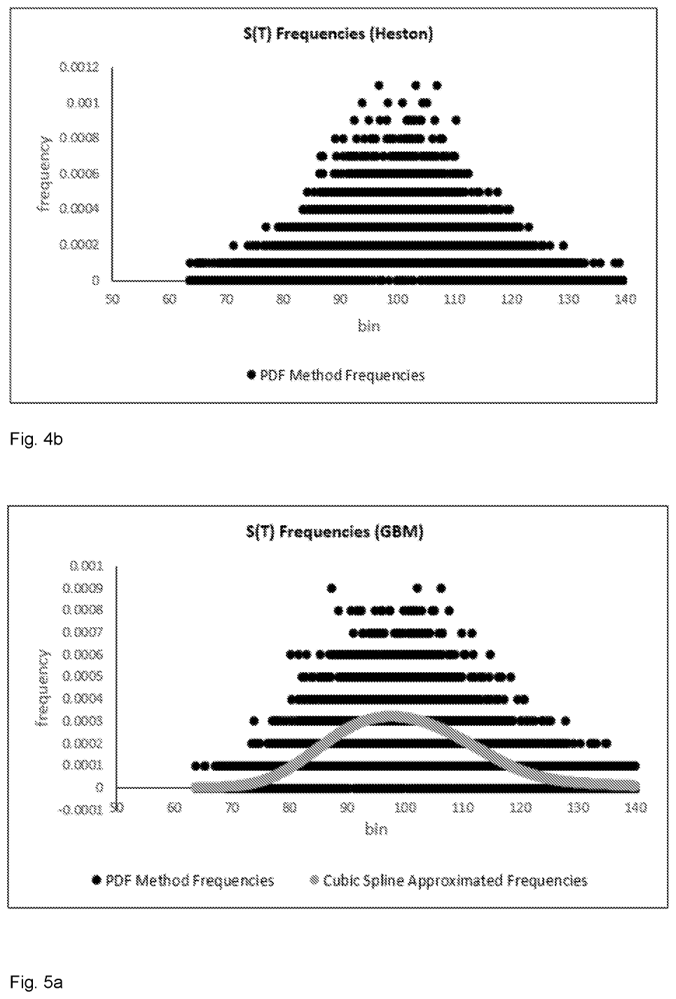

FIG. 4a illustrates a graph of the S(T) frequencies for the GBM (Black-Scholes) model calculated using the PDF method. FIG. 4b illustrates a graph of the S(T) frequencies for the Heston model calculated using the PDF method. Both FIG. 4a and FIG. 4b corresponds to frequency distribution graph for the 10000 S(T) values.

In the case of a vanilla call option, the payoff is obtained as per Equation 10, with S(T) being the computed average for each interval. The option price is obtained by summing up the product of the payoff and the frequency at each interval and discounting the sum as given by Equation 14. Greeks are obtained by shifting the relevant Greek parameters up or down before simulation.

### PDF Smoothing

When computing the frequency distributions as in the previous section, for a fixed number of Monte Carlo simulations N_{S}, the distributions are typically not smooth as observed in FIGS. 4a-4b, and this compromises the accuracy of the option prices being computed. Clearly, increasing the number of simulations will improve accuracy, but at the expense of computational efficiency; practical considerations may not allow the computational time or memory resources required to achieve the desired accuracy.

To combat this, the disclosed method is introduced which utilizes an approximating function in the form of a smoothed interpolation which smooths the frequency distribution. After fitting, the raw percentage frequencies are then substituted with the smoothed frequencies and option prices are determined.

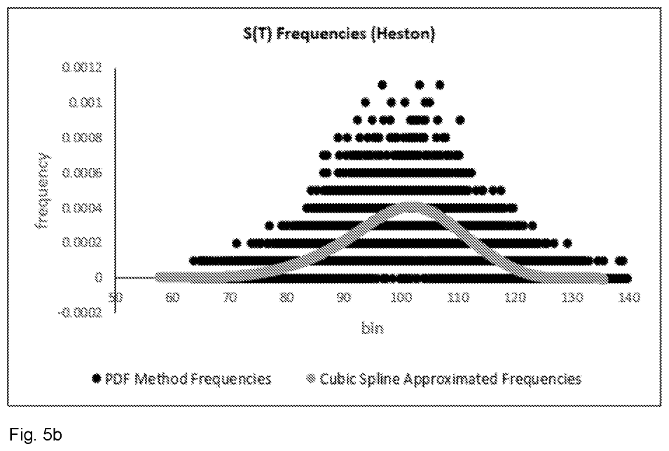

FIGS. 5a-5b shows what the approximated frequencies (in orange) using the same data points as in FIGS. 4a-4b (in black). One observes that the smooth PDF does not match the histogram of FIGS. 4a-4b at the highest values. Rather the smooth PDF is stationed in the middle of the histogram. This is because, during the smoothing process, the interpolation points are equal to the average count of the frequency for the aggregated samples. Using the average count as interpolation points yields the best result as it takes into account the variance of the aggregated multiple sample values that occur at the top of the histogram.

It is also observed that, while the smooth PDFs are reminiscent of a Gaussian function, the smooth PDF for the Heston model is slightly skewed. Therefore, there is an advantage to using parameterised interpolation functions such as cubic splines as a more true representation of the distribution is obtained. This is opposed to simply fitting a Gaussian function of the distribution of aggregated multiple sample values, which would not work for the Heston model. It is noted that stochastic models other than the GBM and Heston model may produce distributions that are not at all reminiscent of a Gaussian function. Therefore, in all situations, it is most advantageous to use parameterised interpolation functions such as cubic splines to smooth the PDFs. Further, cubic splines are local interpolation functions, which allow them to be sensitive to sudden changes in the distribution. This may provide an added advantage if the distribution of aggregated multiple sample values showed high variance.

Using these new approximated frequencies, option prices and Greeks are computed as described above for the smoothed PDF method using Equation 14. For the test case on the same computer, the runtime for obtaining the option price for a single strike price using Monte Carlo method is 0.6476 seconds on average, and for the disclosed method, it is 1.7026 seconds (162.91% higher than the Monte Carlo method). In the disclosed method, the runtime is dependent on the number of bins and it is worth mentioning that the computations were performed over 15955 bins. The run time is usually smaller/larger depending on the bin size.

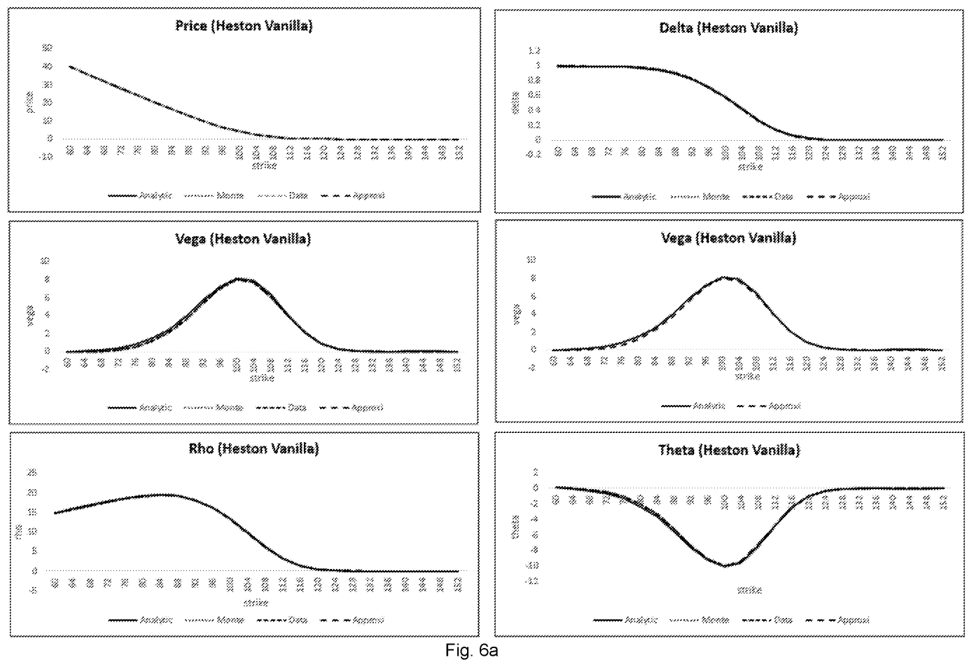

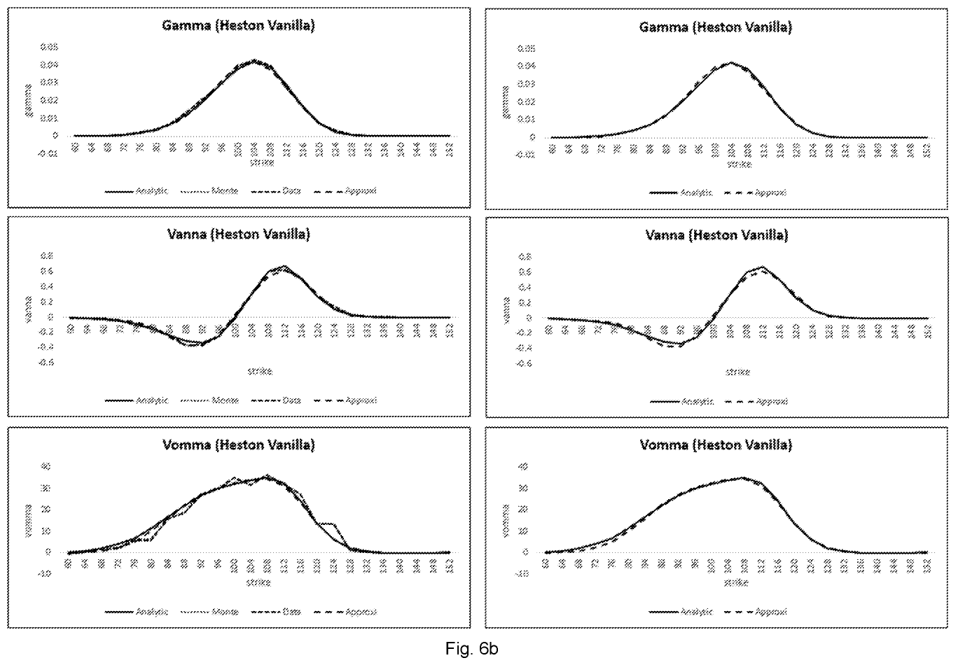

FIGS. 6a-6b illustrate graphs for the vanilla option prices and Greeks under the Heston model. In FIGS. 6a-6b, Monte represents the Monte Carlo method, Data represents the PDF method with no smoothing and Approxi represents the disclosed method.

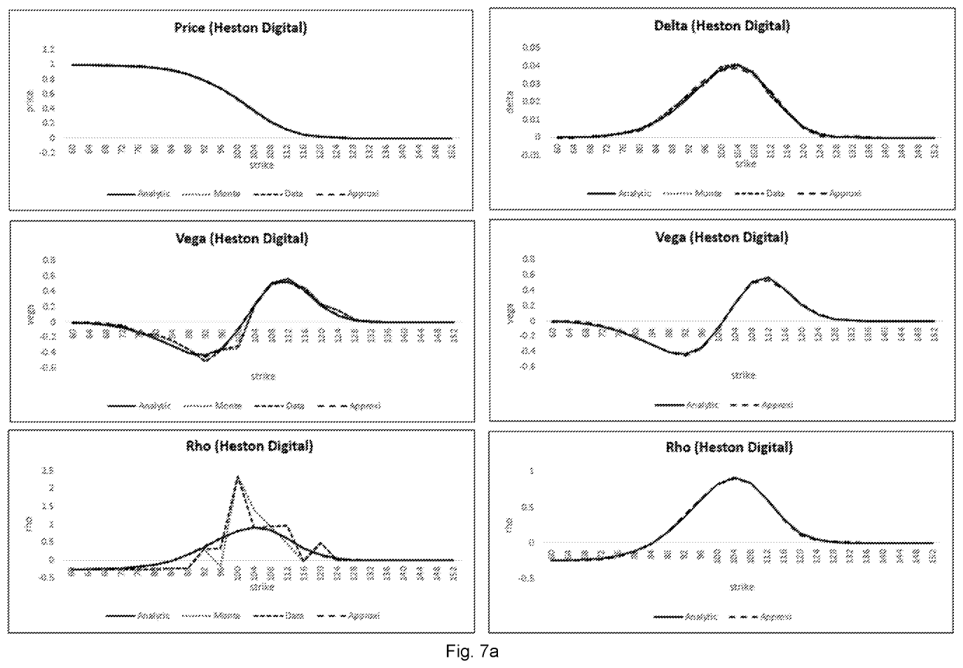

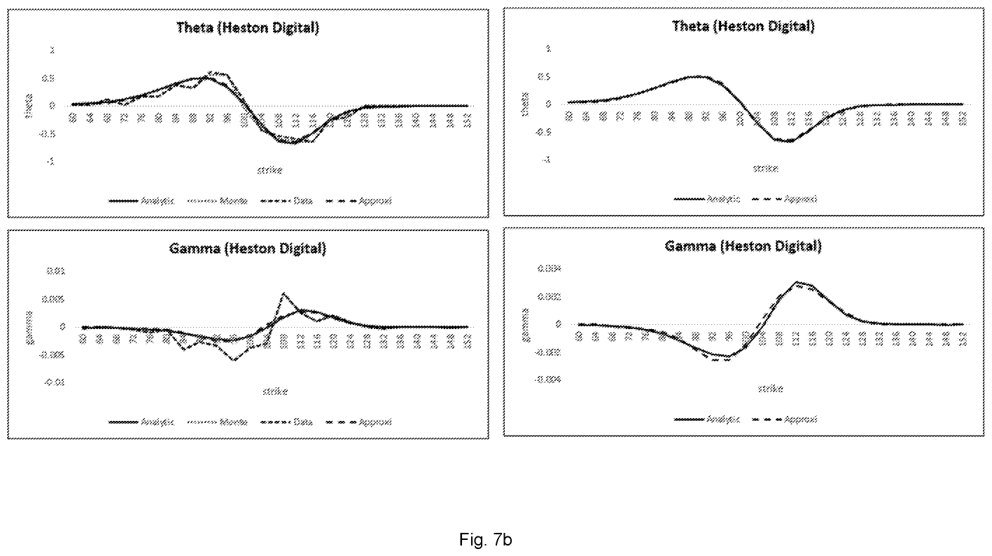

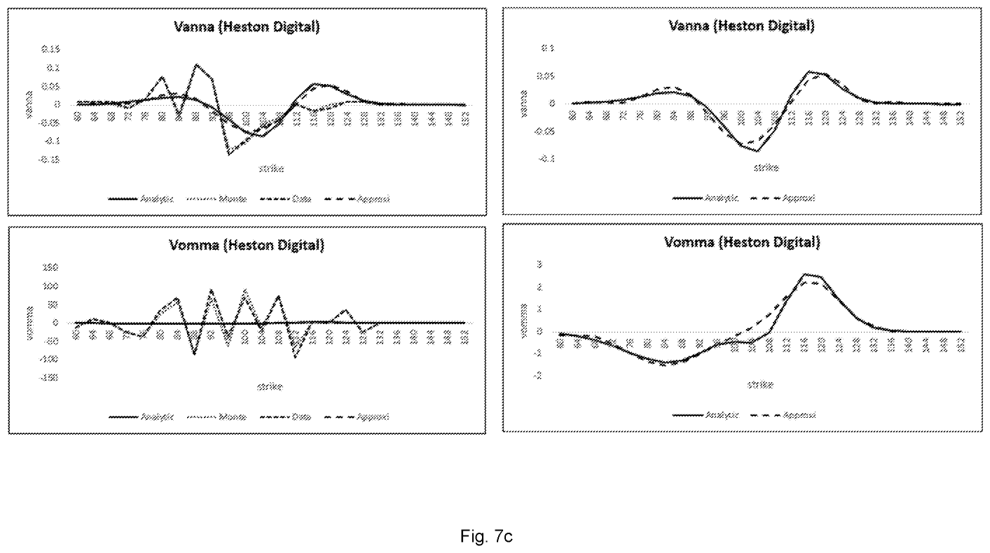

FIGS. 7a-7c illustrate graphs for the digital option prices and Greeks under the Heston model. Monte represents the Monte Carlo method, Data represents the PDF method with no smoothing and Approxi represents the disclosed method.

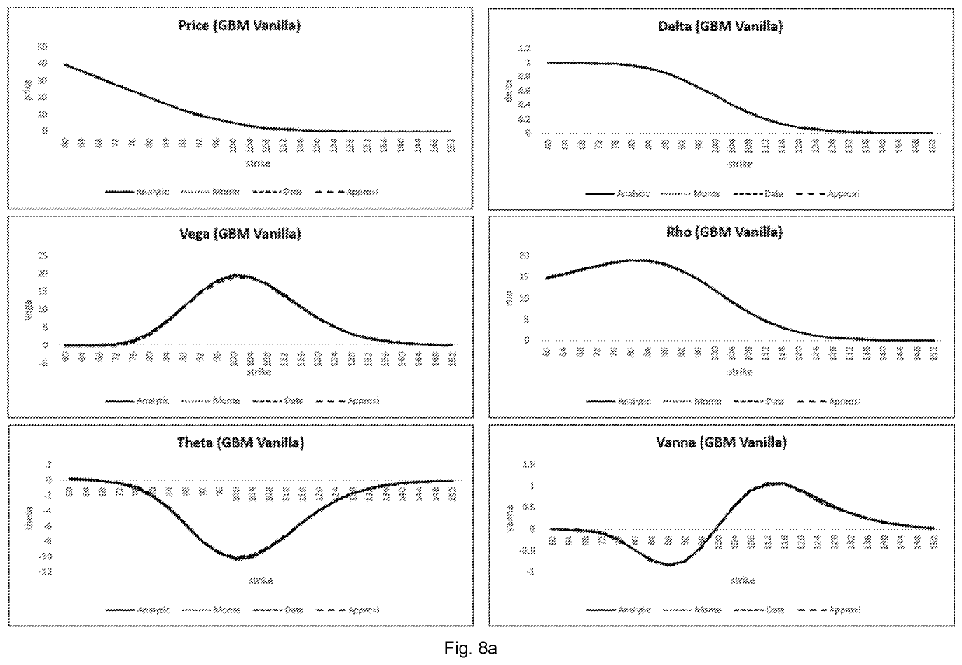

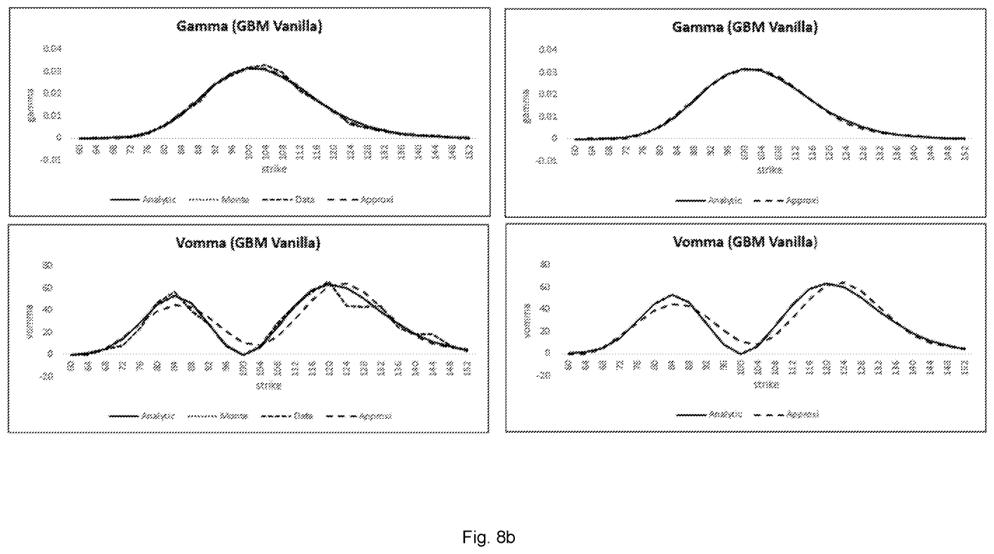

FIGS. 8a-8b illustrates graphs for the vanilla option prices and Greeks under the GBM (Black-Scholes) model. Analytic represents the analytic method, Monte represents the Monte Carlo method, Data represents the PDF method with no smoothing and Approxi represents the disclosed method.

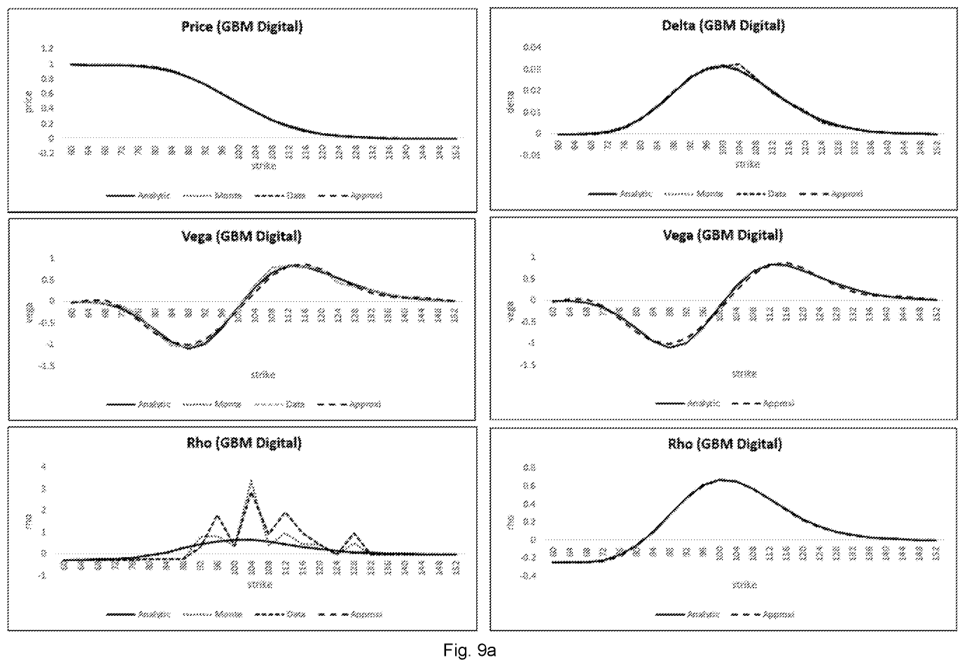

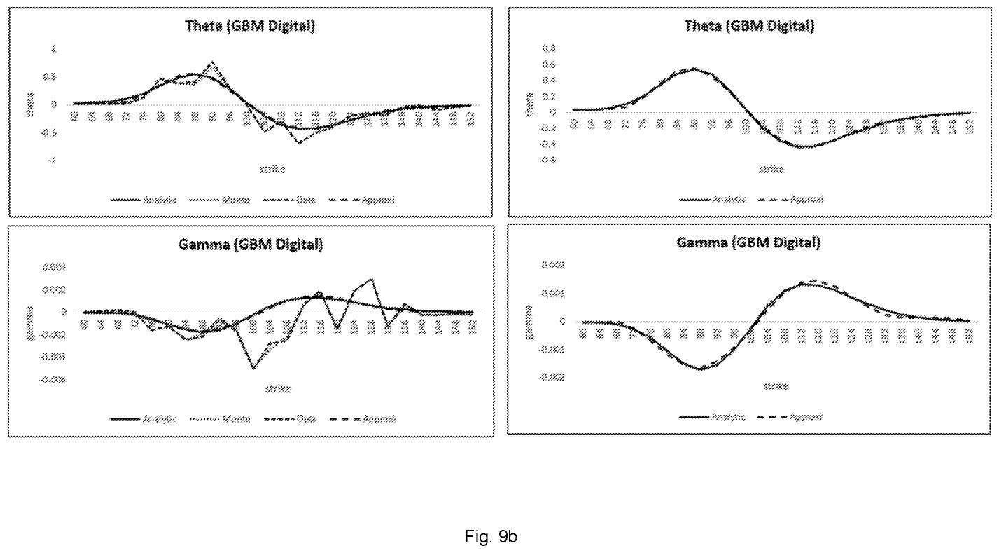

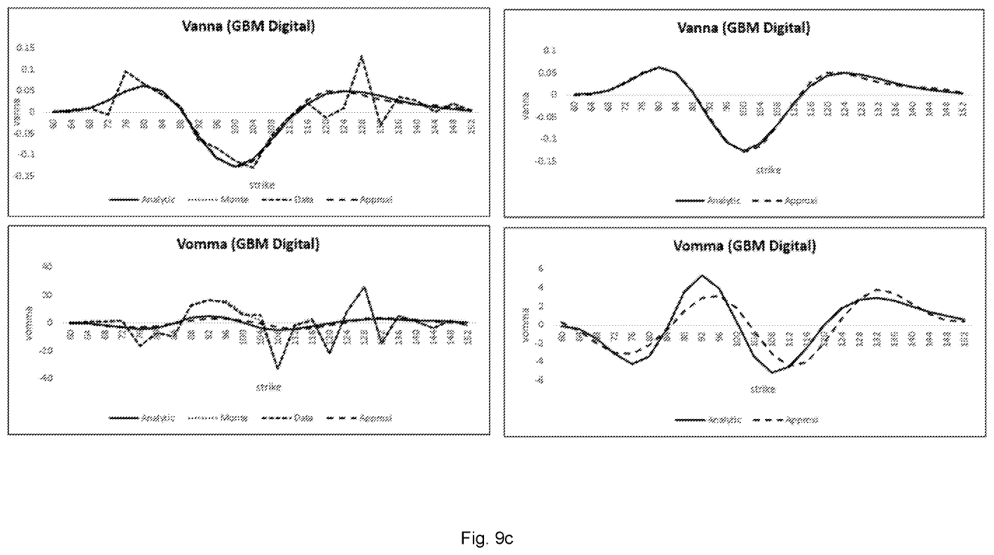

FIGS. 9a-9c illustrates graphs for the digital option prices and Greeks under the GBM (Black-Scholes) model. Analytic represents the analytic method, Monte represents the Monte Carlo method, Data represents the PDF method with no smoothing and Approxi represents the disclosed method.

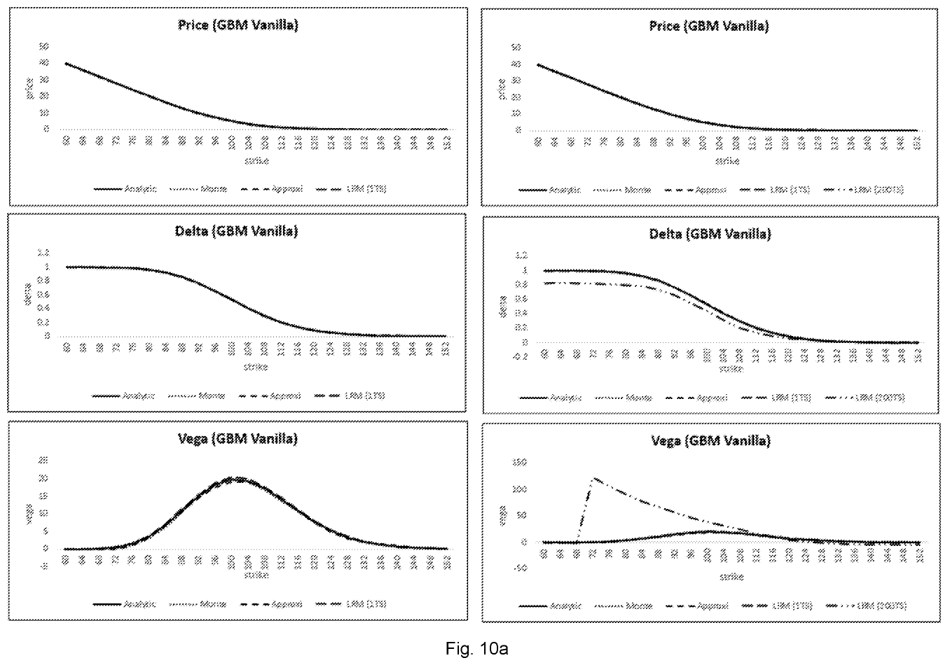

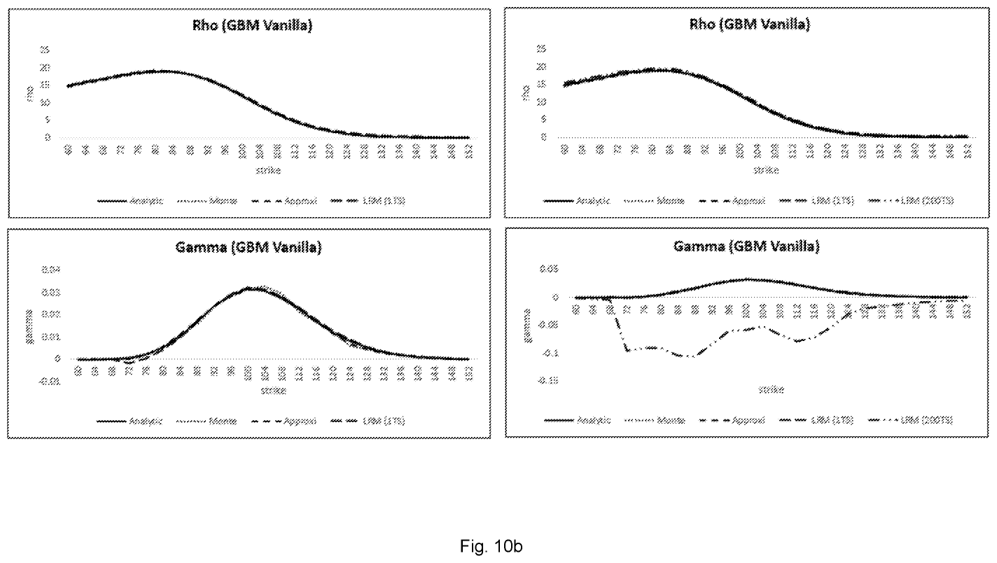

FIGS. 10a-10b illustrates graphs for the vanilla option prices and Greeks under the GBM (Black-Scholes) model with comparison to the likelihood ratio method (LRM). Analytic represents the analytic method, Monte represents the Monte Carlo method, Approxi represents the disclosed method, LRM(1TS) represents the LRM method for 1 time step and LRM(200TS) represents the LRM method for 200 time steps. Monte Carlo and PDF Smoothing values are computed using 200 time steps. It is noted that for GBM model, an analytic solution is available, LRM method can achieve solution by using a single time step, however if analytic solution were not possible, LRM method would need to use multiple time steps and this case demonstrates LRM method with multiple time steps generate less accurate Greek values.

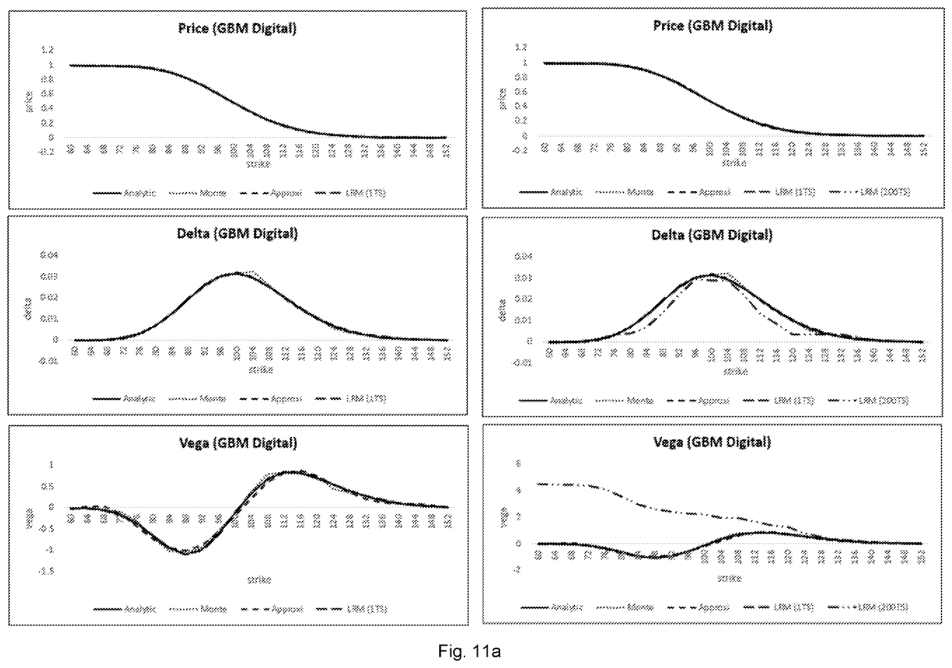

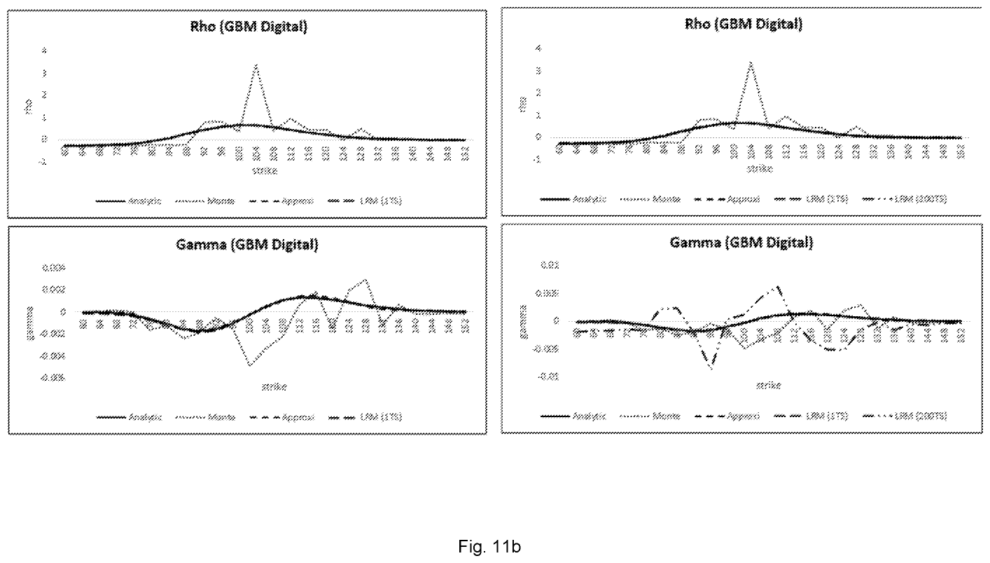

FIGS. 11a-11b illustrates graphs for the digital option prices and Greeks under the GBM (Black-Scholes) model with comparison to the likelihood ratio method (LRM). Analytic represents the analytic method, Monte represents the Monte Carlo method, Approxi represents the disclosed method, LRM(1TS) represents the LRM method for 1 time step and LRM(200TS) represents the LRM method for 200 time steps. Monte Carlo and PDF Smoothing values are computed using 200 time steps.

For vanilla options under both the Heston and the GBM models in FIGS. 6a-6c and FIGS. 8a-8b, the Monte Carlo and the PDF method prices and Greeks are all close to the analytic values. This is slightly different to the case of digital options in FIGS. 7a-7c and FIGS. 9a-9c, in particular, Rho, Theta, Gamma, Vanna and Vomma Greeks. The Monte Carlo and the PDF Method Greek values show some instability across the range of strikes where the computed values deviate from the analytic values in different magnitudes. This instability and lack of accuracy poses a challenge to financial practitioners and has been a source of further research as they seek to find more stable methods.

One of the most noticeable aspects of the results shown in graphs from the disclosed method is that they are smooth and continuous with respect to the strike price. This is one advantage of the disclosed method, as the smoothing of the PDFs causes stability of the sensitivities with respect to the strike price.

| | Heston Vanilla | | | | | |
|---|---|---|---|---|---|---|
| | Strike (76) | | Strike (96) | | Strike (116) | |
| | | Relative | | Relative | | Relative |
| | Value | Error | Value | Error | Value | Error |
| Price | | | | | | |
| Analytic | 24.1518 | | 6.5409 | | 0.1721 | |
| Monte Carlo | 24.1608 | 0.04% | 6.5865 | 0.82% | 0.1758 | 2.15% |
| PDF Method | 24.1608 | 0.04% | 6.5863 | 0.82% | 0.1758 | 2.15% |
| PDF Approximation | 24.1606 | 0.04% | 6.5726 | 1.03% | 0.1710 | 0.62% |
| Delta | | | | | | |
| Analytic | 0.9827 | | 0.7151 | | 0.0589 | |
| Monte Carlo | 0.9859 | 0.3 [symbol] % | 0.7110 | 0.57% | 0.0591 | 0.44% |
| PDF Method | 0.9859 | 0.33% | 0.7110 | 0.57% | 0.0591 | 0.44% |
| PDF Approximation | 0.9854 | 0.27% | 0.7114 | 0.52% | 0.0552 | 6.21% |
| Vega | | | | | | |
| Analytic | 0.7601 | | 7.2382 | | 2.1499 | |
| Monte Carlo | 0.4751 | 37.50% | 7.0403 | 2.73% | 2.1702 | 0.94% |
| PDF Method | 0.4754 | 37.46% | 7.0404 | 2.73% | 2.1701 | 0.94% |
| PDF Approximation | 0.5001 | 34.21% | 7.0776 | 2.22% | 2.1332 | 0.78% |
| Rho | | | | | | |
| Analytic | 18.5305 | | 16.21 [symbol] 9 | | 1.4293 | |
| Monte Carlo | 18.4896 | 0.22% | 16.0804 | 0.84% | 1.4318 | 0.17% |
| PDF Method | 18.4728 | 0. [symbol] 1% | 16.0693 | 0.91% | 1.4250 | 0.30% |
| PDF Approximation | 18.4634 | 0.36% | 16.0693 | 0.91% | 1.3327 | 6.76% |
| Gamma | | | | | | |
| Analytic | 0.0019 | | 0.0297 | | 0.0163 | |
| Monte Carlo | 0.0021 | 12.05% | 0.0292 | 1.69% | 0.0172 | 5.92% |
| PDF Method | 0.0021 | 11.39% | 0.0292 | 1.73% | 0.0172 | 5.90% |
| PDF Approximation | 0.0020 | 6.42% | 0.0313 | 5.41% | 0.0162 | 0.48% |
| Theta | | | | | | |
| Analytic | −1.30901 | | −9.2763 | | −2.4988 | |
| Monte Carlo | −1.02673 | 21.56% | −9.1357 | 1.52% | −2.5143 | 0.62% |
| PDF Method | −1.028 [symbol] 1 | 21.44% | −9.1503 | 1.57% | −2.5110 | 0.49% |
| PDF Approximation | −1.04574 | 20.11% | −9.1583 | 1.49% | −2.4912 | 0.30% |
| Vomma | | | | | | |
| Analytic | 6.50 [symbol] 2 | | 30.1408 | | 24.4809 | |
| Monte Carlo | 6.1400 | 5.58% | 29.7992 | 1.15% | 27.4842 | 12.27% |
| PDF Method | 5.8082 | 10.69% | 29.9881 | 0.51% | 27.5839 | 12.68% |
| PDF Approximation | 5.1657 | 20.57% | 30.3923 | 0.83% | 23.8251 | 2.68% |
| Vanna | | | | | | |
| Analytic | −0.0898 | | −0.2553 | | 0.5094 | |
| Monte Carlo | −0.1068 | 18.86% | −0.2532 | 0.82% | 0.5188 | 1.85% |
| PDF Method | −0.1070 | 19.18% | −0.2535 | 0.69% | 0.5187 | 1.84% |
| PDF Approximation | −0.0626 | 30.36% | −0.2270 | 11.09% | 0.5112 | 0. [symbol] 6% |

[symbol]

indicates data missing or illegible when filed

Table 2 shows the values for vanilla option prices and Greeks under the Heston model for different methodologies. The Monte Carlo, PDF Method and the disclosed method are compared to the analytic method and the relative error is computed. S=100 and the analysis has been done for ATM, ITM and OTM options.

| | Heston Digital | | | | | |
|---|---|---|---|---|---|---|
| | Strike (76) | | Strike (96) | | Strike (116) | |
| | | Relative | | Relative | | Relative |
| | Value | Error | Value | Error | Value | Error |
| Price | | | | | | |
| Analytic | 0.9753 | | 0.6757 | | 0.0493 | |
| Monte Carlo | 0.9796 | 0.44% | 0.6737 | 0.29% | 0.0496 | 0.68% |
| PDF Method | 0.9796 | 0.44% | 0.6737 | 0.29% | 0.0496 | 0.68% |
| PDF Approximation | 0.9794 | 0.42% | 0.67 [symbol] 9 | 0.18% | 0.0497 | 0.79% |
| Delta | | | | | | |
| Analytic | 0.0025 | | 0.0310 | | 0.0141 | |
| Monte Carlo | 0.0026 | 5.63% | 0.0298 | 3.70% | 0.0143 | 1.93% |
| PDF Method | 0.0026 | 5.63% | 0.0299 | 3.54% | 0.0143 | 1.93% |
| PDF Approximation | 0.0023 | 7.72% | 0.0319 | 2.90% | 0.0142 | 0.73% |
| Vega | | | | | | |
| Analytic | −0.1279 | | −0.3427 | | 0.4179 | |
| Monte Carlo | −0.1547 | 20.96% | −0.3610 | 5.36% | 0.4470 | 6.95% |
| PDF Method | −0.1547 | 20.96% | −0.3610 | 5.36% | 0.4470 | 6.95% |
| PDF Approximation | −0.1202 | 6.07% | −0.3581 | 4.51% | 0.3971 | 4.98% |
| Rho | | | | | | |
| Analytic | −0.1817 | | 0.6054 | | 0.3386 | |
| Monte Carlo | −0.2449 | 34.80% | −0.1684 | 127.82% | −0.0124 | 103.66% |
| PDF Method | −0.2449 | 34.80% | 0.3278 | 45.84% | −0.0124 | 103.66% |
| PDF Approximation | −0.1887 | 3.88% | 0.6152 | 1.63% | 0.3295 | 2.67% |
| Gamma | | | | | | |
| Analytic | −0.0004 | | −0.0023 | | 0.0028 | |
| Monte Carlo | −0.0009 | 148.13% | −0.00 [symbol] 1 | 163.24% | 0.0011 | 61.56% |
| PDF Method | −0.0009 | 148.13% | −0.0060 | 158.92% | 0.0011 | 61.56% |
| PDF Approximation | −0.0004 | 14.23% | −0.0025 | 10.79% | 0.0026 | 9.50% |
| Theta | | | | | | |
| Analytic | 0.1966 | | 0.3542 | | −0.4919 | |
| Monte Carlo | 0.1783 | 9.34% | 0.5651 | 59.84% | −0.6437 | 30.8 [symbol] % |
| PDF Method | 0.1783 | 9.34% | 0.5561 | 59.84% | −0.5437 | 30.86% |
| PDF Approximation | 0.1859 | 5.45% | 0. [symbol] 7 [symbol] 4 | 5.44% | −0.4713 | 4.18% |
| Vomma | | | | | | |
| Analytic | −0.9498 | | −0.58 [symbol] 5 | | 2.6085 | |
| Monte Carlo | −36.6243 | 3756.16% | −61.6360 | 10430.49% | 2.5806 | 1.07% |
| PDF Method | −36.6243 | 3756.16% | −37.8153 | 6360.75% | 2.5806 | 1.07% |
| PDF Approximation | −0.9898 | 4.21% | −0.5846 | 0.13% | 2.2039 | 15.51% |
| Vanna | | | | | | |
| Analytic | 0.0134 | | −0.0 [symbol] 99000 | | 0.0582 | |
| Monte Carlo | 0.0172 | 28.58% | −0.120 [symbol] 376 | 201.60% | −0.0172 | 129.53% |
| PDF Method | 0.0172 | 28.58% | −0.1203 [symbol] 76 | 201.60% | −0.0172 | 129.53% |
| PDF Approximation | 0.0119 | 10.71% | −0.0527009 | 32.08% | 0.0433 | 25.58% |

[symbol]

indicates data missing or illegible when filed

Table 3 shows the values for digital option prices and Greeks under the Heston model for different methodologies. The Monte Carlo, PDF Method and the disclosed method are compared to the analytic method and the relative error is computed. S=100 and the analysis has been done for ATM, ITM and OTM options.

| | GBM Vanilla | | | | | |
|---|---|---|---|---|---|---|
| | Strike (76) | | Strike (96) | | Strike (116) | |
| | | Relative | | Relative | | Relative |
| | Value | Error | Value | Error | Value | Error |
| Price | | | | | | |
| Analytic | 24.1197 | | 7.2510 | | 0.8012 | |
| LRM Method (1TS) | 24.1 [symbol] 4 | | 7.2236 | | 0.8121 | |
| LRM Method (200TS) | 24.1359 | 0.07% | 7.2920 | 0.56% | 0.8300 | 3.50% |
| Monte Carlo | 24.0895 | 0.1 [symbol] % | 7.1925 | 0.81% | 0.7927 | 1.07% |
| PDF Method | 24.0895 | 0.1 [symbol] % | 7.1925 | 0.81% | 0.7926 | 1.07% |
| PDF Approximation | 24.0918 | 0.12% | 7.1971 | 0.74% | 0.77 [symbol] 7 | 3.0 [symbol] % |
| Delta | | | | | | |
| Analytic | 0.98371 | | 0.6555 | | 0.1 [symbol] 9 | |
| LRM Method (1TS) | 0.98074 | | 0.6542 | | 0.1 [symbol] 0 | |
| LRM Method (200TS) | 0.8104 [symbol] | 17.61% | 0. [symbol] 525 | 15.71% | 0.0858 | 35.98% |
| Monte Carlo | 0.9880 [symbol] | 0.24% | 0.65 [symbol] 2 | 0.55% | 0.1 [symbol] 08 | 2.35% |
| PDF Method | 0. [symbol] 09 | 0.24% | 0. [symbol] 581 | 0.85% | 0.1398 | 2.35% |
| PDF Approximation | 0.98 [symbol] 35 | 0. [symbol] % | 0.6541 | 0.22% | 0.1305 | 2.55% |
| Vega | | | | | | |
| Analytic | 1.4821 | | 18.2545 | | 10.7804 | |
| LRM Method (1TS) | 1. [symbol] 0 [symbol] 4 | | 18.7810 | | 11.1928 | |
| LRM Method (200TS) | 1.2911 | 22.88% | 47.3374 | 159.82% | 10.5536 | 2.10% |
| Monte Carlo | 1.0198 | 31.19% | 18.0413 | 1.17% | 10.5534 | 2.11% |
| PDF Method | 1.0192 | 3 [symbol] .23% | 18.0408 | 1.17% | 10.5541 | 2.10% |
| PDF Approximation | 0.9780 | 34.01% | 17.4305 | 4.51% | 10.8253 | 0.42% |
| Rho | | | | | | |
| Analytic | 18.5627 | | 14.5741 | | 3.14 [symbol] 2 | |
| LRM Method (1TS) | 18.7360 | | 14.7982 | | 3.4698 | |
| LRM Method (200TS) | 19.2271 | [symbol] .58% | 15.10 [symbol] 8 | 3.65% | 3.5583 | 13.03% |
| Monte Carlo | 18.5100 | 0.28% | 14.4409 | 0.91% | 3.0418 | 3.38% |
| PDF Method | 18.4410 | 0.65% | 14.4205 | 1.05% | 3.0230 | 3.38% |
| PDF Approximation | 1 [symbol] .4894 | 0.66% | 14.42 [symbol] 0 | 1. [symbol] 2% | 3.0245 | 3.93% |
| Gamma | | | | | | |
| Analytic | 0.0024 | | 0.0294 | | 0.0173 | |
| LRM Method (1TS) | 0.0028 | | 0.0295 | | 0.0179 | |
| LRM Method (200TS) | −0.008 [symbol] | 461.92% | −0.0602 | 305.03% | −0.0714 | 511.81% |
| Monte Carlo | 0.0020 | 17.85% | 0.0284 | 3.21% | 0.0171 | 1.51% |
| PDF Method | 0.0020 | 17.34% | 0.0284 | 3.17% | 0.0171 | 1.49% |
| PDF Approximation | 0.0020 | 1 [symbol] .89% | 0.0289 | 1.52% | 0.0173 | 0.01% |
| Theta | | | | | | |
| Analytic | −1.0049 | | −9.8110 | | −5.5271 | |
| Monte Carlo | −0.7 [symbol] 08 | 24.2 [symbol] % | −9.4597 | 1.57% | −5.8872 | 2.53% |
| PDF Method | −0.7 [symbol] 7 | 23.70% | −9.4696 | 1.47% | −5.3907 | 2.47% |
| PDF Approximation | −0.7120 | 29.15% | −9. [symbol] 885 | 2.31% | −5.4386 | 2.60% |
| Vomma | | | | | | |
| Analytic | 29.0757 | | 8.4853 | | 58.5945 | |
| Monte Carlo | 2 [symbol] . [symbol] 847 | 18.85% | 7.5187 | 11.42% | 56.3618 | 3.31% |
| PDF Method | 25.8759 | 17.88% | 7. [symbol] 095 | 10.52% | 56.4327 | 3.69% |
| PDF Approximation | 28.0 [symbol] 18 | 3.49% | 21.1739 | 149.53% | 49.2590 | 1 [symbol] .9 [symbol] % |
| Vanna | | | | | | |
| Analytic | −0.2556 | | −0.4157 | | 1.0584 | |
| Monte Carlo | −0.2224 | 12.99% | −0.3999 | 3.04% | 1.0602 | 0.17% |
| PDF Method | −0.2218 | 13. [symbol] 0% | −0. [symbol] 988 | 5.37% | 1.0651 | 0.17% |
| PDF Approximation | −0.2517 | 1.5 [symbol] % | −0.4389 | 8.08% | 1.0499 | 0.80% |

[symbol]

indicates data missing or illegible when filed

Table 4 shows the values for vanilla option prices and Greeks under the GBM (Black-Scholes) model for different methodologies. The Monte Carlo, PDF Method, disclosed method, LRM(1TS) and LRM(200TS) are compared to the analytic method and the relative error is computed. LRM(1TS) and LRM(200TS) represents the values computed using the LRM method under 1 time step and 200 time steps respectively. S=100 and the analysis has been done for ATM, ITM and OTM options.

| | GBM Digital | | | | | |
|---|---|---|---|---|---|---|
| | Strike (76) | | Strike (96) | | Strike (116) | |
| | | Relative | | Relative | | Relative |
| | Value | Error | Value | Error | Value | Error |
| Price | | | | | | |
| Analytic | 0.9770 | | 0.6073 | | 0.1086 | |
| LRM Method (1TS) | 0.976 [symbol] | | 0.60 [symbol] 1 | | 0.1077 | |
| LRM Method (200TS) | 0.9766 | 0.04% | 0.6052 | 0.33% | 0.1110 | 2.22% |
| Monte Carlo | 0.9807 | 0.3 [symbol] % | 0.6050 | 0. [symbol] % | 0.1054 | 2.90% |
| PDF Method | 0.9807 | 0.3 [symbol] % | 0.6050 | 0.86% | 0.1054 | 2.90% |
| PDF Approximation | 0.9821 | 0.52% | 0.6043 | 0.4 [symbol] % | 0.1020 | 6.04% |
| Delta | | | | | | |
| Analytic | 0.0031 | | 0.0304 | | 0.0149 | |
| LRM Method (1TS) | 0.0088 | | 0.0302 | | 0.0148 | |
| LRM Method (200TS) | 0.0054 | 7.82% | 0.0292 | 0.98% | 0.0085 | 42.75% |
| Monte Carlo | 0.0028 | 10.93% | 0.0301 | 0.98% | 0.0148 | 0.21% |
| PDF Method | 0.002 [symbol] | 10.95% | 0.0300 | 1.30% | 0.0143 | 0.21% |
| PDF Approximation | 0.0081 | 0.95% | 0.0306 | 0.61% | 0.0148 | 2.0 [symbol] % |
| Vega | | | | | | |
| Analytic | −0.3554 | | −0.6225 | | 0.8214 | |
| LRM Method (1TS) | −0.3851 | | −0.6291 | | 0.8 [symbol] 24 | |
| LRM Method (200TS) | 4.0932 | 1251.75% | 2.2500 | 461.57% | 1.4731 | 73.25% |
| Monte Carlo | −0.3027 | 14.82% | −0.5 [symbol] 7 | 9.09% | 0.8089 | 1.52% |
| PDF Method | −0.3027 | 14.82% | −0. [symbol] 08 | 9.88% | 0.8139 | 0.92% |
| PDF Approximation | −9.4275 | 20.29% | −0. [symbol] 46 | 5.05% | 0.8781 | 6.90% |
| Rho | | | | | | |
| Analytic | −0.1 [symbol] 2 | | 0.6088 | | 0.3446 | |
| LRM Method (1TS) | −0.1 [symbol] 19 | | 0.6038 | | 0.3440 | |
| LRM Method (200TS) | −0.1 [symbol] 47 | 0.90% | 0.6153 | 1.07% | 0.3534 | 56.98% |
| Monte Carlo | −0.2452 | 47.49% | 0.8412 | 35.18% | 0.4899 | 36. [symbol] 6% |
| PDF Method | −0.2452 | 47.49% | 1.8 [symbol] 87 | 203.21% | 0.9562 | 180. [symbol] 7% |
| PDF Approximation | −0.1769 | 8.44% | 0.60 [symbol] 0 | 0.47% | 0.8867 | 2. [symbol] 0% |
| Gamma | | | | | | |
| Analytic | −0.0006 | | −0.0010 | | 0.0013 | |
| LRM Method (1TS) | −0.0007 | | −0.0011 | | 0.0013 | |
| LRM Method (200TS) | −0.001 [symbol] | 189.01% | 0.0004 | 141.75% | 0.0033 | 100.40% |
| Monte Carlo | −0.0016 | 178.60% | −0.0015 | 48.88% | 0.0019 | 43.95% |
| PDF Method | −0.001 [symbol] | 17 [symbol] .60% | −0.0017 | 88.75% | 0.0019 | 43.95% |
| PDF Approximation | −0.0007 | 17.17% | −0.0009 | 5.69% | 0.0015 | 13.45% |
| Theta | | | | | | |
| Analytic | 0.2 [symbol] 39 | | 0.2989 | | −0.4228 | |
| Monte Carlo | 0.1287 | 35.89% | 0.3159 | 5.68% | −0.49 [symbol] 1 | 16.75% |
| PDF Method | 0.1287 | 36.89% | 0.3159 | 5.68% | −0.4832 | 16.75% |
| PDF Approximation | 0.1812 | 11.15% | 0.2720 | 9.01% | −0.4273 | 1.27% |
| Vomma | | | | | | |
| Analytic | −4.2009 | | 8.9538 | | −2.4711 | |
| Monte Carlo | −16. [symbol] 7 [symbol] 0 | 301.65% | 15.8804 | [symbol] 08.71% | 2.9770 | 220.50% |
| PDF Method | −1 [symbol] .8750 | 301.6 [symbol] % | 14.8879 | 278.48% | 1.9851 | 180.35% |
| PDF Approximation | − [symbol] .1072 | 2 [symbol] .0 [symbol] % | 3.1290 | 20.45% | −4.0158 | 52.50% |
| Vanna | | | | | | |
| Analytic | 0.0486 | | −0.1074 | | 0.0213 | |
| Monte Carlo | 0.096 [symbol] | 99.25% | −0.0519 | 25.75% | 0.0199 | 6.96% |
| PDF Method | 0.095 [symbol] 8 | 99.25% | −0.0819 | 2 [symbol] .75% | 0.0199 | 6.96% |
| PDF Approximation | 0.0504 | 3.69% | −0.1048 | 2.44% | 0.0289 | 35.25% |

[symbol]

indicates data missing or illegible when filed

Table 5 the values for digital option prices and Greeks under the GBM (Black-Scholes) model for different methodologies. The Monte Carlo, PDF Method, disclosed method, LRM(1TS) and LRM(200TS) are compared to the analytic method and the relative error is computed. LRM(1TS) and LRM(200TS) represents the values computed using the LRM method under 1 time step and 200 time steps respectively. S=100 and the analysis has been done for ATM, ITM and OTM options.

On analyzing the actual values for the strikes 76, 96 and 116, it is observed that the Monte Carlo and the PDF method have negligible differences, for all the results in Table 2. This may differ depending on the bin size, and the smaller the bin size, the better the accuracy. An optimal bin size has been used, which ensures that results with better accuracy are obtained in the shortest amount of time.

Similar results are observed in Table 4 in the case of GBM Vanilla option prices and Greeks. In the case of digital options, we casually observe slightly different Monte Carlo and PDF results in the case of digital options, for both the Heston and GBM models. The reason for this discrepancy is due to the nature of digital options which assign a value of 1 if the price is greater than the strike or zero otherwise. Since the set of values being used for this criteria are different in terms of magnitude and the quantity, there are bound to be slight differences. The results for Rho displayed in FIG. 9a-9c show that although there are inaccuracies with some strikes, for the bulk number of strikes the values between the two methods are similar. Overall, the figures demonstrate expected results; the values obtained using the unsmoothed PDF method are close to the Monte Carlo values.

The disclosed method prices and Greeks for vanilla options are close to the analytic values as evidenced by the graphs in all figures. From inspection, calculational stability is also observed. PDF Smoothing values are analysed in comparison to Monte Carlo and unsmoothed PDF method. Examining the numerical results in detail in the tables, it is observed that the disclosed method has a relative error whose performance is dependent on the moneyness of the option, and the Greek type, i.e. Delta, Vega, Theta, Gamma and Vomma have a low relative error, whilst Rho and Vanna have higher relative errors for the same strike. In addition, under the GBM model, Vega has a high relative error when the strike is 76 and 96, and a lower relative error when the strike is 116. Vanna has a lower relative error when the strike is 76, and a higher relative error when the strike is 96 and 116 under a similar model. Although this performance fluctuates, the disclosed method performs better than the two methods overall.

Next, the behaviour of the disclosed method for the prices and Greeks of digital options across a range of strikes is examined. FIGS. 7a-7c and FIG. 9a-9c are the graphs of both the GBM and the Heston model for digital options. A number of graphs in the second column only show the results for the analytic method and the disclosed method in order to provide clearer graphs showing the performance of this method in comparison to the analytic method. All the graphs observed indicate that this methodology results in values that are smooth and stable (with no kinks) across strikes and close to the analytic values. This is a desirable property, as one is able to price and compute Greeks for different option types which would normally have been difficult to price and value its Greeks. Of particular interest is Rho, Theta, Gamma, Vanna and Vomma. Pricing these Greeks using Monte Carlo and PDF Method results in unstable values across strikes. Hence there has been a need for an alternative method. This study has shown us that the disclosed method can be used reliably to price digital options. The table of values in Table 3 and Table 5 also tell a similar story, i.e. single digit percentage relative errors in comparison to the double or triple digit percentage errors observed in the Monte Carlo and PDF methods.

### Comparison to the LRM Method.

The prices and Greeks (Delta, Vega, Rho and Gamma) obtained using the GBM model for both the vanilla and digital options are compared to the LRM method (with fixed-sample path principle), a commonly used methodology in literature. The purpose of this study is to observe how the disclosed method fares to the LRM method, with the analytic method used as the benchmark. In this way, one can observe an advantage in using the disclosed method over other existing methods.

Some problems being solved by financial practitioners require models that use time stepping. A comparison of the LRM method to the disclosed method is made for 1 time step and 200 time steps. All the Monte Carlo Method and the disclosed method estimates have been computed using 200 time steps. Normally, if analytic solutions are available for a model such as the GBM and Heston models, single one time step can be used by LRM method, however if analytic solution is not available for a model, multiple time stepping is used to achieve solution by the LRM method. For most sophisticated models commonly used by industry practitioners, analytic solutions are not available and therefore the LRM method can only rely on multiple time steps.

The graphical results for this comparison are given in FIGS. 10a-10b and FIGS. 11a-11b. The graphs on the left of FIGS. 10a-10b and FIGS. 11a-11b show a comparison of the Monte Carlo method, PDF Smoothing and the LRM method (1 time step), with the analytic method as the benchmark. For both vanilla and digital options, one observes that the values obtained using LRM method with 1 time step are close to the analytic values, similar to the disclosed method. The graphs on the right hand side show the comparison of all the methods on the left hand side of FIGS. 10a-10b and FIGS. 11a-11b in addition to the LRM method values obtained using 200 time steps. The values for Delta, Vega and Gamma show a large deviation from the analytic values and the LRM(200TS) values. This behaviour observed in the methodology is what often renders the LRM method unusable, especially where time stepping is of importance. Introducing time stepping in the computation of Rho does not result in a large deviation from the analytic values.

A closer look at the values obtained from these methodologies helps in determining the best method to use under different circumstances. Table 4 and Table 5 show the numerical values comparison. The analytic method is used as the benchmark. In the case of a single time step, the LRM method seems to be perform quite well and can be a strong contender to the disclosed method. It fails when multiple time steps are introduced, and the disclosed method becomes valuable. This is also shown by the large % errors seen in the majority of the Greeks presented in the table.

### CONCLUSION

A new approach of using PDF Smoothing in Monte-Carlo method for pricing financial options and calculating Greeks is disclosed. Through numerical results, the disclosed method is demonstrated to generate more stable Greeks in comparison to conventional Monte Carlo method and, standard PDF method and the LRM method. The disclosed method can be generically implemented for any underlying stochastic models and options types. The disclosed method is particularly effective for options with discontinuous payoffs and for different asset dynamics where it is not possible to get closed form solutions. In addition to this, the method is also effective in pricing option types which require time stepping, and in which other methods like the LRM method do not perform well.

The disclosed method is not limited to any underlying asset model. The Black-Scholes model and Heston stochastic volatility model are chosen as example stochastic model because close-form analytic solutions are available as benchmark to validate the numerical results produced by the disclosed method. For demonstration purposes, standard vanilla options (with continuous payoff) and digital options (with discontinuous payoffs) are chosen to illustrate the improvement to the Greek values from using the disclosed method.

In using this method, for more accurate values of Greeks, a very small bin size is required when generating the PDF, which may impact the computing speed. However, for robust Greek values (particularly the second-order Greeks), the trade off lies in the fact that less Monte Carlo simulations are required when using this method. An analysis of the amount of time that it takes to obtain the results under this method in comparison to conventional Monte Carlo method under different number of simulations might be beneficial.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A computer implemented method for computationally stable calculation of a sensitivity of a financial derivative, the method comprises:
repeatedly evaluating a model along a sample path with a first parameter set to obtain multiple first sample values;
aggregating the multiple first sample values to obtain a first density profile;
smoothing the first density profile by interpolating the aggregated multiple first sample values using a parameterised interpolation function to obtain a first smooth density profile;
repeatedly evaluating the model along the sample path with a second parameter set to obtain multiple second sample values;
aggregating the multiple second sample values to obtain a second density profile;
smoothing the second density profile by interpolating the aggregated multiple second sample values using the parameterised interpolation function to obtain a second smooth density profile,
wherein the first parameter set and the second parameter set are perturbed relative to one another in at least one parameter; and
calculating a finite difference based on the first smooth density profile and the second smooth density profile, subject to a discontinuous payoff function applied to the smooth density profile, to obtain the sensitivity of the financial derivative with respect to the at least one parameter, the sensitivity being stable as a result of the smoothing.

2. The method of claim 1, wherein aggregating the multiple first and second sample values to obtain the density profile comprises dividing a range of the multiple first and second sample values into intervals and counting a number of the multiple first and second sample values in each interval.

3. The method of claim 2, wherein calculating the finite difference comprises evaluating the first smooth density profile, the second smooth density profile and the discontinuous payoff function at an average of each interval.

4. The method of claim 3, wherein smoothing the first and second density profile comprises interpolating a frequency of the multiple first and second sample values occurring at the average of each interval.

5. The method of claim 2, wherein calculating the finite difference further comprises summing over each interval.

6. The method of claim 1, wherein the discontinuous payoff function is discontinuous at a strike price, and the sensitivity of the financial derivative is smooth and continuous with respect to the strike price.

7. (canceled)

8. The method of claim 1, wherein the model comprises a stochastic process.

9. The method of claim 1, wherein the sample path outputs a price of an underlying asset, and each of the multiple first and second sample values is indicative of the price of the underlying asset at a time of maturity.

10. (canceled)

11. The method of claim 9, wherein the first smooth density function and the second smooth density function are functions with respect to the price of the underlying asset.

12. The method of claim 9, wherein each of the first parameter set and the second parameter set comprise one or more of initial price of the underlying asset, risk free interest rate, dividend rate and volatility.

13. The method of claim 12, wherein the volatility is variable with respect to time.

14. The method of claim 13, wherein the volatility is variable simultaneously with evaluating the model.

15. The method of claim 1, wherein the financial derivative is an option price.

16. The method of claim 12, wherein the at least one parameter comprises one or more of the price of the underlying asset, the risk free interest rate, the dividend rate and the volatility.

17. The method of claim 1, wherein the parameterised interpolation function comprises a cubic spline or polynomial.

18. The method of claim 1, wherein the first parameter set and the second parameter set are perturbed relative to one another by addition or subtraction of an incremental change in the at least one parameter.

19. The method of claim 1, wherein calculating the finite difference based on the first smooth density profile and the second smooth density profile comprises performing a subtraction of the first smooth density profile from the second smooth density profile.

20. The method of claim 18, wherein calculating a finite difference based on the first smooth density profile and the second smooth density profile further comprises dividing a result of the subtraction by the incremental change in the parameter.

21. A non-transitory computer readable medium with software code stored thereon that, when executed by a computer, causes the computer to perform the method of claim 1.

22. A computer system for computationally stable calculation of a sensitivity of a financial derivative, the computer system comprising:
a processor configured to:
repeatedly evaluate a model along a sample path with a first parameter set to obtain multiple first sample values;
aggregate the multiple first sample values to obtain a first density profile;
smooth the first density profile by interpolating the aggregated multiple first sample values using a parameterised interpolation function to obtain a first smooth density profile;
repeatedly evaluate the model along the sample path with a second parameter set to obtain multiple second sample values;
aggregate the multiple second sample values to obtain a second density profile;
smooth the second density profile by interpolating the aggregated multiple second sample values using the parameterised interpolation function to obtain a second smooth density profile,
wherein the first parameter set and the second parameter set are perturbed relative to one another in at least one parameter; and
calculate a finite difference based on the first smooth density profile and the second smooth density profile, subject to a discontinuous payoff function applied to the smooth density profile, to obtain the sensitivity of the financial derivative with respect to the at least one parameter, the sensitivity being stable as a result of the smoothing.
